(19) United States
(12) Patent Application Publication
(10) Pub. No.: US 2008/0270203 A1
(43) Pub. Date: Oct. 30, 2008

(54) Assessment of Risk to Domain Names, Brand Names and the Like

(75) Inventors: Robert Holmes, New York, NY (US); Kanchan Mhatre, Coopersburg, PA (US); Vincenzo A. D'Angelo, Ridgewood, NY (US); Mark Y. Flegg, Clinton, NJ (US)

Correspondence Address: FISH & RICHARDSON P.C., P.O. BOX 1022, MINNEAPOLIS, MN, 55440-1022, US

(73) Assignee: Corporation Service Company, Wilmington, DE (US)

(21) Appl. No.: 11/857,117

(22) Filed: Sep. 18, 2007

Related U.S. Application Data
(60) Provisional application No. 60/926,545, filed on Apr. 27, 2007.

(51) Int. Cl. G06Q 99/00

(52) U.S. Cl. 705/7; 705/1

(57) ABSTRACT

Assessment of risk to a specified name that represents at least one of a brand name, a domain name, a trademark, a service mark or a business entity name, includes acquiring data relating to the specified name, and quantifying risks to the specified name in the event a third-party has obtained, or were to obtain, a registration to the same name or a variant of the name. Risk scores are associated with the potential and actual registrations. An interactive display showing the risk scores is provided. Monitoring domain names and parsing domain names also are disclosed.

### CROSS-REFERENCE TO RELATED APPLICATION(S)

This application claims the benefit of priority of U.S. Provisional Patent Application No. 60/926,545, filed on Apr. 27, 2007.

### TECHNICAL FIELD

This disclosure relates to assessment of risk to domain names, brand names and the like.

### BACKGROUND

Current estimates are that the Internet has more than one billion active users and is growing at a significant rate. Furthermore, there are now hundreds of extensions under which domain names may be registered. For example, types of extensions include the following:

1. Generic top-level domains (gTLDs—e.g., .COM).

2. Country-code top-level domains (ccTLDs—e.g., FR) and associated second-level domains. Of these second-level domains, some have generic business associations (e.g., .COM.FR for companies). Other second-level domains relate to specific industries (e.g., .AVOCAT.FR for law firms). Furthermore, certain countries offer second-level extensions that relate to provinces within the country (e.g., .BJ.CN for Beijing, China).

3. Regional top-level domains (e.g., .EU).

4. Sponsored top-level domains (e.g., .MOBI).

5. CentralNIC second-level domains (e.g., .DE.COM). CentralNIC is a company that owns two-letter gTLD domains, the second level of which matches the two-letter ISO code of a particular country. CentralNIC then positions those extensions as an alternative to the local ccTLD extension where that may already be registered.

Unfortunately, combined with the monetization of domain names, the Internet has created an environment for the growth of cyber-squatting and other illegal practices of registering someone else's trademark, service mark, brand name or Uniform Resource Locator (“URL”).

Cyber-squatters, for example, no longer rely only on registering names for resale back to brand owners to generate revenue. For cyber-squatters, registering another entity's brand names and variants of those names has become a lucrative business that relies on click-through traffic in which revenues are based on the number of times customers or potential customers click on a link or banner advertisement displayed on another web site.

Potential customers often are diverted away from a particular company as a result of third parties seeking to profit from the company's brands and trademarks. Moreover, monitoring illegal or improper activities such as cyber-squatting can be time-consuming and expensive. Likewise, registering all variants of a company's brands, for example, in all Internet extensions can be prohibitively costly, particularly in view of the hundreds of extensions under which a domain name potentially can be registered. With so many extensions from which to choose, a brand owner often faces the difficult decision as to which domains to register. Trade-offs between costs and the threat or possibility of improper use of the company's domain names presents difficult choices.

This disclosure addresses some of these and other issues related to the promotion and protection of domain names, brand names and the like.

### SUMMARY

The disclosure relates to assessment of risk to domain names, brand names, and the like.

The details of one or more implementations are set forth in the accompanying drawings and the description below, as well as the claims.

Among other things, a machine-implemented method is disclosed and includes acquiring data relating to a name that represents at least one of the following: a brand name, a domain name, a trademark, a service mark or a business entity name. The method includes quantifying risks to the name in the event a third-party has obtained, or were to obtain, a registration to the same name or a variant of the name. A risk score is associated with each potential or actual registration. The method includes providing an interactive display showing the risk scores.

Some implementations can help a brand owner identify, quantify and rank risks to the brand. Various factors, including registry rules, registration costs and market potential can be taken into account. Some implementations can help the brand owner understand and visualize the trade-offs between risk, costs and budget, and can help the brand owner eliminate unacceptable risk, mitigate marginal risk and ignore acceptable risk. Furthermore, implementations can allow the brand owner or other user to view the impact of changes to risk tolerance or budget in a convenient way.

Another aspect discloses, among other things, a machine-implemented method for assessing risk to a specified name that represents at least one of a brand name, a domain name, a trademark, a service mark or a business entity name. The method includes monitoring domain name activity (e.g., new domain name registrations), and classifying risk based on at least one of the following (i) similarity between a domain string of a monitored domain name and the specified name and (ii) a type of web content in a web site to which the monitored domain name is pointing.

Yet another aspect discloses, among other things, a machine-implemented method includes parsing left-hand-side and right-hand-side strings of a monitored domain name that is a variant of the specified name. The resulting data can be used, for example, to spot trends in improper or undesirable third-party behavior.

Other features and advantages will be apparent from the following detailed description, the accompanying drawings and the claims.

### BRIEF DESCRIPTION OF THE DRAWINGS

FIG. 1 illustrates an example of a system that is operable to classify, quantify, prioritize and predict risk related to use of domain names.

FIG. 2 illustrates an example of a graphical user interface that includes a risk map.

FIGS. 3A through 3D illustrate examples of risk maps.

FIGS. 4 and 5 illustrate aspects of the interaction between a risk engine and the risk map.

FIG. 6 illustrates an example of a summary report.

FIG. 7 illustrates an example of a detailed report.

FIG. 8 illustrates an example of policy rules.

FIG. 9 is a flow chard illustrating a method of calculating a risk score for a particular domain name extension.

FIGS. 10A and 10B illustrate an example of a uniform distribution mapping for a first input variable.

FIGS. 11A and 11B illustrate an example of a uniform distribution mapping for a second input variable.

FIGS. 12A and 12B illustrate an example of a uniform distribution mapping for a third input variable.

FIGS. 13A and 13B illustrate an example of determining membership values.

FIG. 14 illustrates an example of rules for determining an output group based on the input variables.

FIG. 15 illustrates an example of ranges of risk scores for each output group.

FIG. 16 illustrates an example of a report based on output generated by a monitoring module that incorporates web content classification.

### DETAILED DESCRIPTION

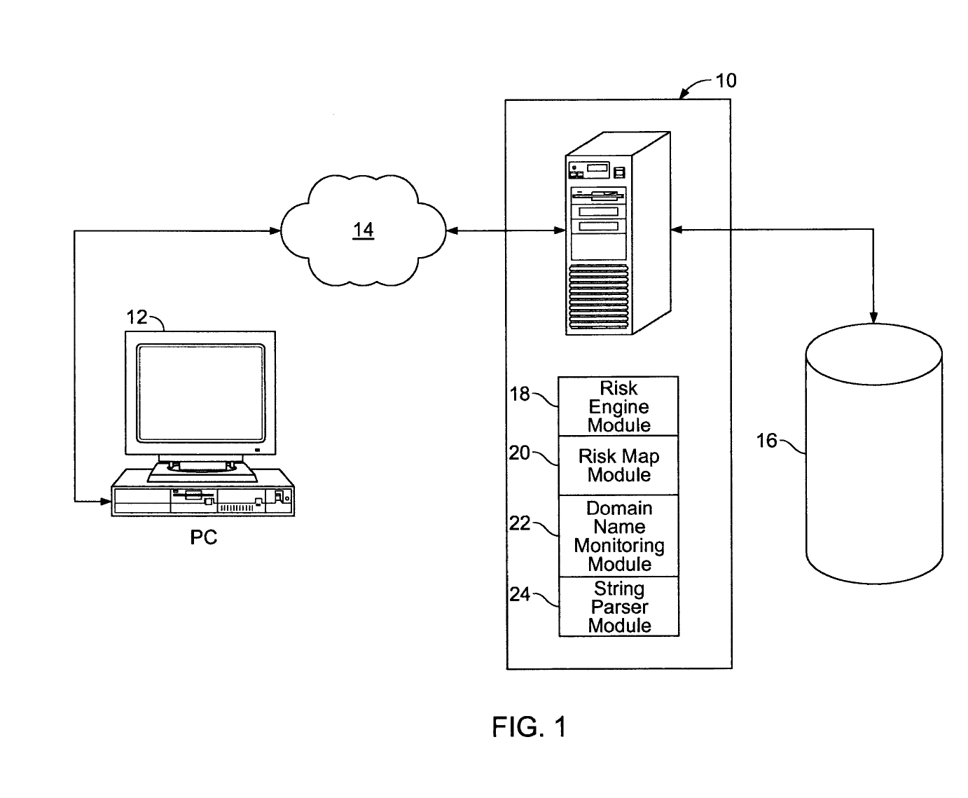

FIG. 1 shows an example of a system that is operable to classify, quantify, prioritize and predict risk related to use of domain names. The system is operable to present interactive displays to facilitate a user's visualization of the risks, and to facilitate the user's treatment of such risk, for example, in the Internet space. The system allows a user (e.g., a brand owner) to make informed, effective trade-offs between risk and budget.

Various features of the system can be implemented in hardware, software, or a combination of hardware and software. For example, some features of the system can be implemented in computer programs executing on programmable computers. Each program can be implemented in a high level procedural or object-oriented programming language to communicate with a computer system. Furthermore, each such computer program can be stored on a storage medium, such as memory readable by a general or special purpose programmable computer or processor, for configuring and operating the computer when the storage medium is read by the computer to perform the function described above.

In some implementations, the system includes a set of software-based tools hosted, for example, on one or more servers 10 that can be accessed, for example, from a personal computer 12 or other user device through the Internet or through some other computer network 14. One or more databases 16 are associated with the servers 10. Information related to the risk associated with a particular domain name, for example, can be delivered to and displayed on a user's personal computer to allow the user to interact with the display through a graphical user interface. In some implementations, the user is given access to the risk-related information through an Extranet or through on-line subscription rights. The system also can be implemented as a stand-alone system.

The implementation described in detail below uses, as an example, risk associated with domain names such as those used in connection with the Internet. However, aspects of the system and the disclosed techniques also can be used in connection with risk assessment for other types of names, including brand names, trademarks, service marks, and business entity names.

Various aspects of the software-based tools include the following:

(1) A risk engine module 18 is operable to obtain registry, market and client/brand data, and to quantify and predict the risk, according to domain extension, to the client's brand based on possible improper or undesirable Internet use by a third party. In some implementations, this module uses fuzzy logic to calculate risk and to generate a risk score (and associated risk rank) for each extension.

(2) A risk map module 20 allows a user to visualize risk associated with various extensions of a domain name. Domain name extensions are plotted, for example, on a radar chart based on trigonometric calculations, availability of the extension, and registrant data provided by a third-party. In addition, the risk map enables a user to interact with the displayed information through a graphical user interface so as to express the user's risk tolerance and reconcile that to the current risk exposure. The risk engine generates a list of recommendations that is updated dynamically based on the user input. The module also allows the user to interact with the displayed information (e.g., by increasing or decreasing the risk tolerance or budget), with the recommendations being updated dynamically in accordance with these changes. For ease of reference, the tool also can reconcile third-party registrations to World Intellectual Property Organization (“WIPO”) and National Arbitration Forum (“NAF”) data to support a Dispute Resolution Policy (“DRP”) cases or other reclaim activities.

(3) The risk engine module 18 and risk map module 20 are operable to generate a domain policy automatically (e.g., which domain names should the client register and where should they be registered), which can be used to drive future decisions. The domain policy can be used to audit future registration activity automatically.

(4) A domain name monitoring module 22 incorporates a web content classification feature and is operable to classify risk based on (a) the similarity of a domain string to a brand name and (b) the web content (if any) to which the domain is pointing. For example, an exact match of the brand name is more likely to be confused than a typographical or other variant. Similarly, if the domain name is not pointing to any web content, it is likely to be less harmful to the brand.

(5) A left-hand-side (“LHS”) and right-hand-side (“RHS”) string parser module 24 is operable to parse out the left-hand-side and right-hand-side strings of wildcard variants. This data is used to spot trends in improper or undesirable third-party behavior. For example, the module can determine that the third party favors the LHS string “www”, as it seeks to benefit from people typing in a URL such as “www.csc.com” without the dot (i.e., “wwwcsc.com”).

Implementations of the various modules can include one or more servers and databases.

Additional details of an implementation of the system are described below.

### Risk Map

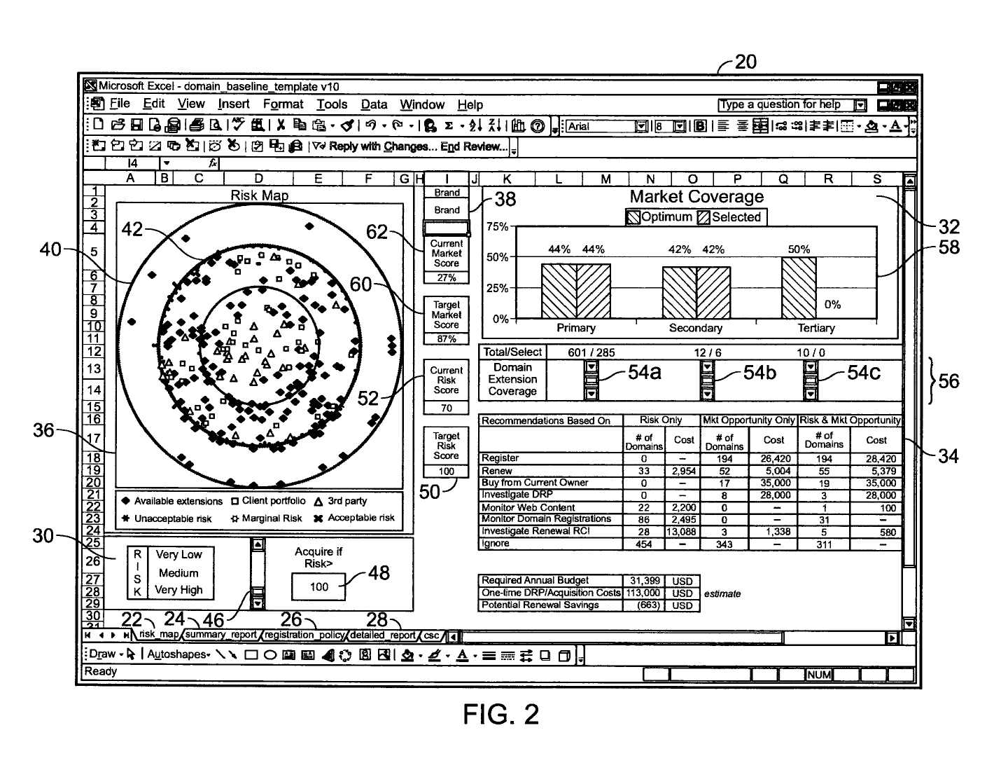

FIG. 2 illustrates an example of a screen 20 that can be displayed, for example, on the brand owner's personal computer or other user terminal. The screen includes a report that is generated by the risk map module in connection with a particular brand name and delivered to the brand owner's personal computer. In this case, the report provides information about the risks and costs for domain name extensions associated with the particular brand name. As explained in greater detail below, the user can interact with the system through a graphical user interface so as to select or change certain parameters and to obtain dynamically updated information based on the user-specified criteria.

The screen 20 includes various tabs 22, 24, 26, 28 that a user can select. FIG. 2 illustrates information in the report that is displayed when the risk map tab 22 is selected. The report includes a risk map section 30, a market coverage section 32 and a recommendations section 34.

The risk map section 30 includes a two-dimensional map 36 that allows a user to visualize the domain name space in a way that presents an indication of the relative importance of domain name extensions in promoting and protecting the particular brand name identified in block 38. The risk map plots each extension associated with the particular brand name at a distance from the map's center that is inversely proportional to a risk score for that extension. Thus, if the risk score=r, the distance from origin will be set equal to (100−r). The risk scores are obtained from the risk engine module, discussed in greater below.

In the illustrated example, different symbols on the map indicate whether the extension already is part of the brand owner's (i.e., client's) portfolio, whether the extension is registered by a third-party, or whether the extension still is available (i.e., not currently registered by the client or a third-party). Thus, in FIG. 2, a square on the risk map 36 indicates an extension already registered by the client, a triangle indicates an extension registered by a third-party, and a diamond indicates an extension that currently is available. Different colors can be used for the various symbols to facilitate a user's differentiating between the status of the extensions.

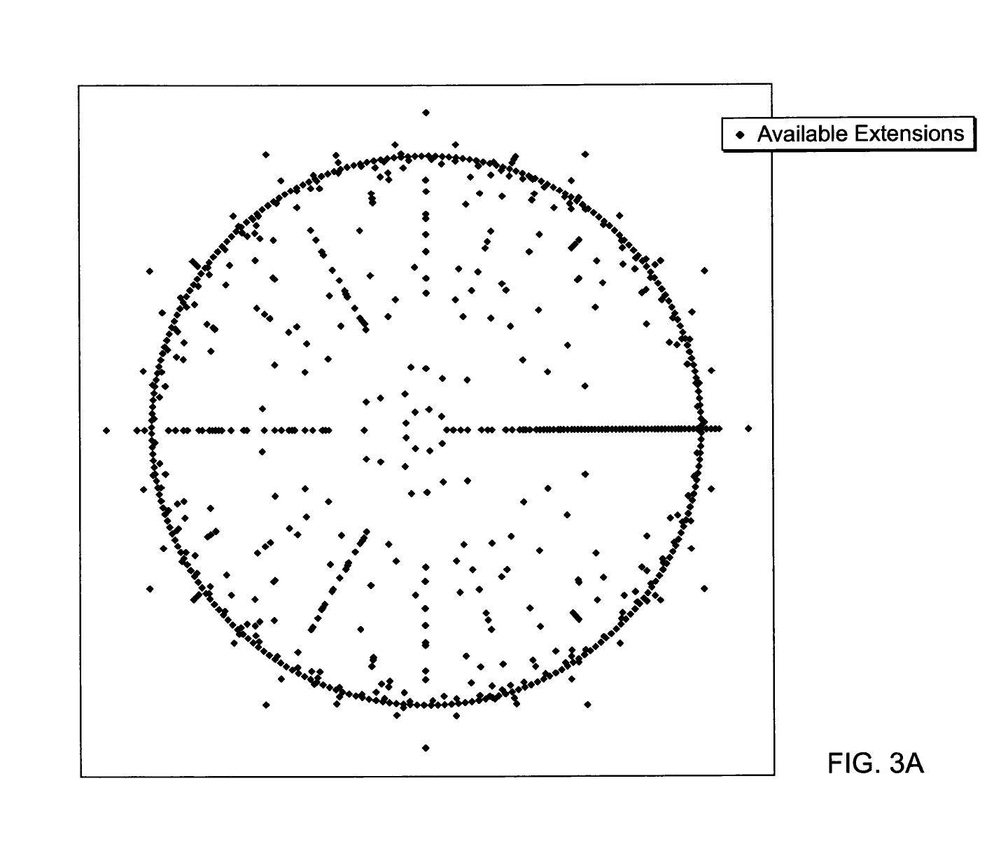

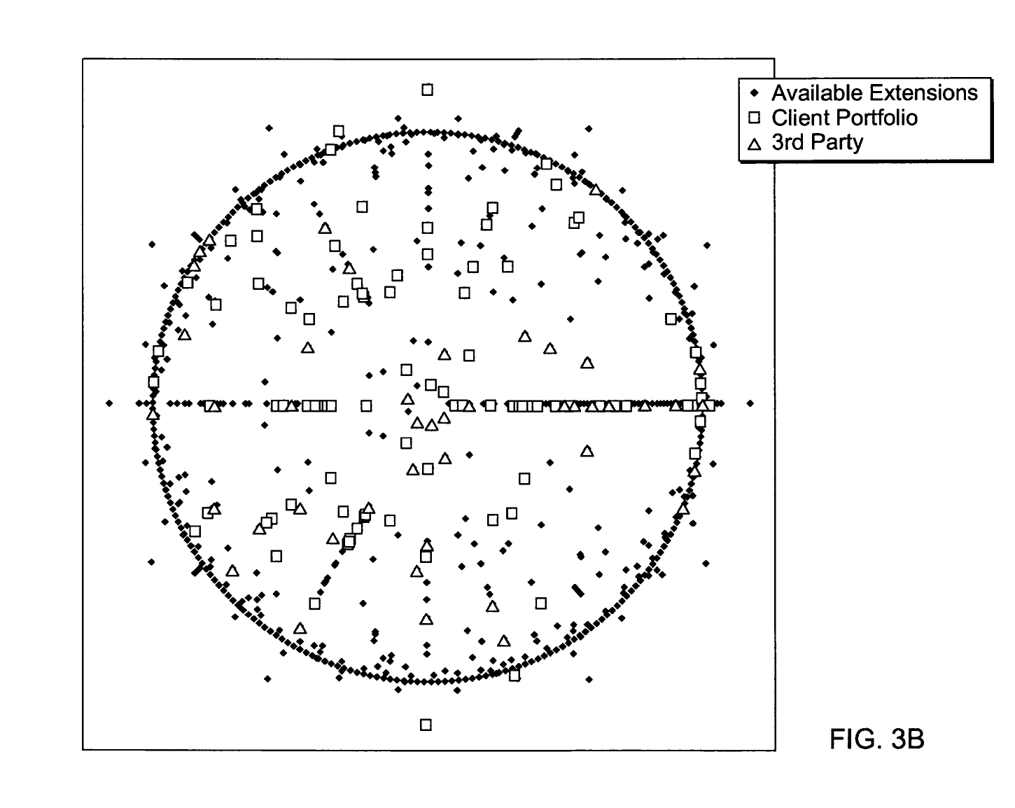

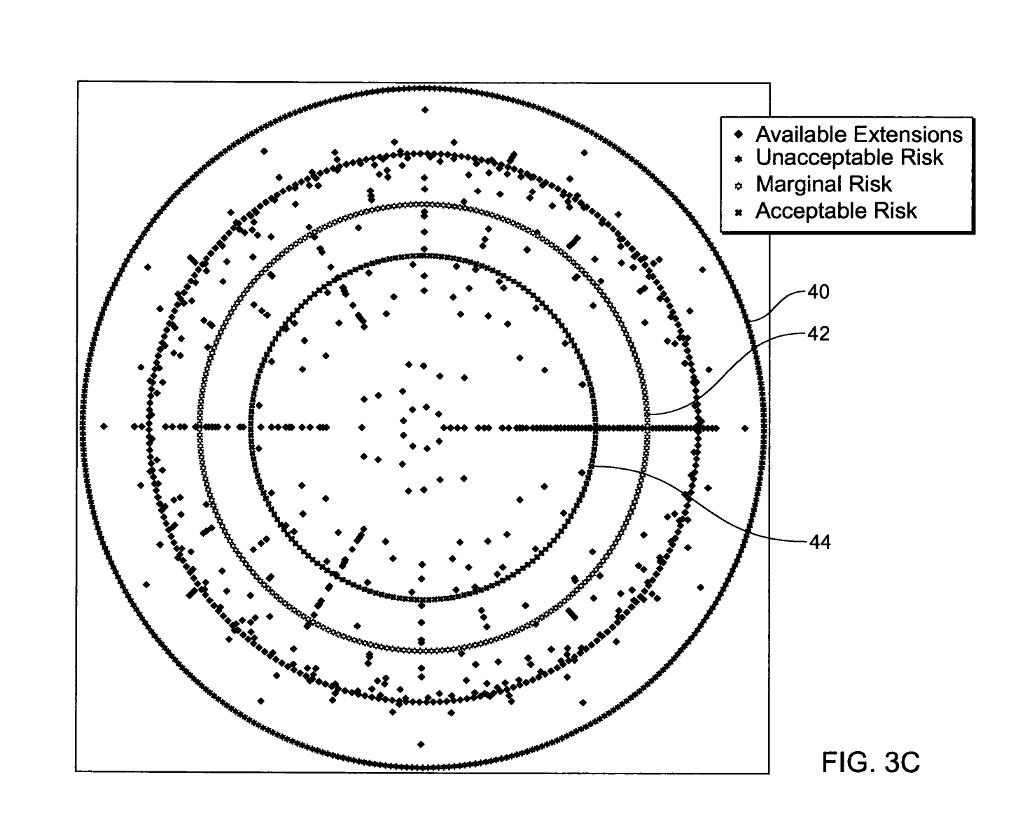

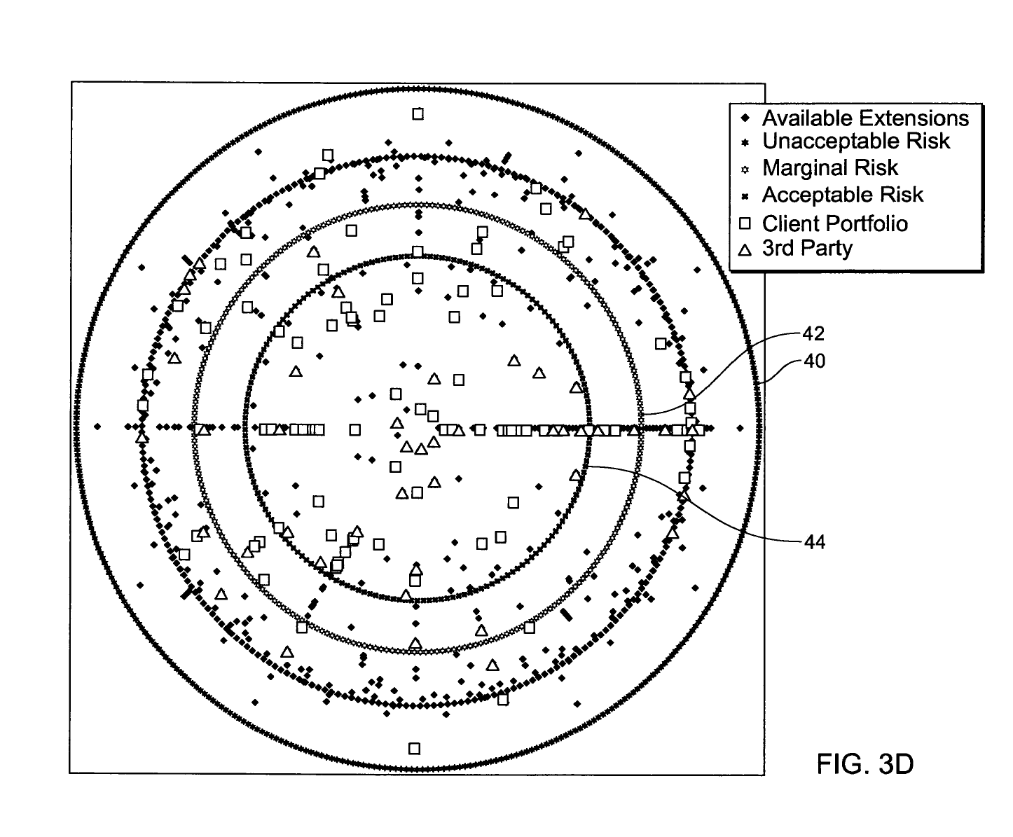

FIG. 3A illustrates an enlarged version of a risk map that shows only available extensions. FIG. 3B illustrates an enlarged version of a risk map with the client and third-party extensions as well.

Each extension is plotted on a single map so that all extensions are visible in the same view. Extensions that are closer to the map's center, and that are registered by a third-party or are available, represent greater risk to the client' brand name listed in block 38. Extensions that are further from the map's center, even though they may be registered by a third-party or are available, represent less risk to the client's brand name.

The risk map module accommodates the fact that multiple extensions may share the same risk score by deriving a unique X-Y coordinate for each extension so that extensions will not overlap on the displayed chart. One method of obtaining a unique X-Y coordinate for each domain name extension is set forth below.

Let N=number of extensions with same risk score.

If N=1, then the risk score is unique among the extensions.

If N<>1, then the risk score is not unique among extensions.

Let n=cumulative number of extensions with the same risk score.

The percentage of the number of extensions with same risk score=n/N

Calculate the angle used to derive the angular distance between the location on the risk map for extensions that have the same risk score:

Angle=360*(n/N).

This angle is translated into radians (A) for ease of calculating the trigonometric equations below:

X=COS(A)*(100−r), and

Y=SIN(A)*(100−r),

where (X, Y) provide the unique X-Y coordinates for each extension having a risk score r.

Table 1 below illustrates examples of unique X-Y coordinates for subsets of extensions that have the same risk score and that, therefore, are plotted at the same distance from the center of the risk map.

TABLE 1

| | | | Number of | | | |
|---|---|---|---|---|---|---|
| | | | extensions | Angle | | |
| | | Distance | with | for | | |
| | Risk | from | same risk | plotting | | |
| Extension | score | origin | score | extension | X | Y |
| .COM | 99 | 1 | 1 | 360 | 1.00 | 0.00 |
| .CO.UK | 88 | 12 | 3 | 120 | −6.00 | 10.39 |
| .DE | 88 | 12 | 3 | 240 | −6.00 | −10.39 |
| .US | 88 | 12 | 3 | 360 | 12.00 | 0.00 |
| .CO.IN | 62 | 38 | 6 | 60 | 19.00 | 32.91 |
| .CO.ZA | 62 | 38 | 6 | 120 | −19.00 | 32.91 |
| .HU.COM | 62 | 38 | 6 | 180 | −38.00 | 0.00 |
| .IR | 62 | 38 | 6 | 240 | −19.00 | −32.91 |
| .RO | 62 | 38 | 6 | 300 | 19.00 | −32.91 |
| .SA.COM | 62 | 38 | 6 | 360 | 38.00 | 0.00 |

As shown in the example of FIG. 2, the risk map 36 also includes several concentric circles or rings 40, 42, with the center of the map coinciding with the centers of the circles. FIGS. 3C and 3D illustrate enlarged versions of risk maps that include three such circles 40, 42, 44. A different color can be used to display each circle to facilitate viewing. The circles indicate levels of risk that are based on a user-specified risk tolerance. In particular, the radius of each circle is inversely proportional to the risk tolerance specified by the user using the movable bar 46 (FIG. 2). In the illustrated examples, the space within the inner circle 44 defines an unacceptable or high-risk area. The space between the inner circle 44 and middle circle 42 defines a marginal risk area. The space between the middle circle 42 and outer circle 40 defines an acceptable or low-risk area. The risk map 36 of FIG. 2 (and FIG. 3D) illustrates the user-specified risk tolerance circles overlaid on the risk exposure data (e.g., the data of FIG. 3B). That makes it easy for the user to visualize the number and status of domain name extensions that fall within each level of risk.

In the example of FIG. 2, the user-specified risk tolerance level is set at 100, which means that the user is willing to accept a high level of risk. In that case, the inner circle 44 of FIGS. 3C and 3D, which indicates the boundary between unacceptable and marginal risk areas, collapses to a point at the center of the map 36 (i.e., there are no extensions that are shown as having an unacceptable level of risk associated with them).

As noted above, the user can change the risk-tolerance level by moving the bar 46 (FIG. 2) upwards or downwards. When the user changes the risk-tolerance level, the system dynamically adjusts the radius of the circles to reflect the user-specified risk-tolerance level. A lower risk-tolerance level indicates that the user is less willing to take risk. A numerical value (e.g., on a scale of 0-100) is associated with the user-specified risk tolerance level and is indicated in the block 48 adjacent the movable bar 46, as well as in the block 50, to indicate a target risk score. Another block 52 indicates a current risk score, which represents an aggregated weighted average calculated by the risk engine based on the risk exposure data for the displayed extensions. A high value for the current risk score indicates the brand is exposed to a high risk that third-parties already have acquired or may acquire extensions similar to the particular brand name identified in block 38.

### Risk Management Recommendations

The risk map module incorporates business logic or policy rules to translate risk exposure and risk tolerance information into a set of recommendations or proposed actions. Examples of such policy rules are set forth below:

1. If the risk score associated with a domain name extension is greater than the risk tolerance selected by the customer using the movable bar 46 (and displayed in boxes 48 and 50), then the client should seek to eliminate the risk as follows:
a. If the domain name with the particular extension is available for registration, the client should seek such registration.
b. If the domain name with the particular extension already is registered to a third-party, the client should investigate a possible reclaim (e.g., either through DRP, litigation or purchasing the domain name).
c. If the domain name with the particular extension already is registered to the client, then no action is required (other than to ensure it is renewed at the appropriate time).

2. If the risk score associated with a domain name extension is less than the acceptable risk level expressed by the client, but greater than the level deemed to be marginal, then the client should seek to mitigate the risk as follows:
a. If the domain name with the particular extension is available for registration, it should be monitored.
b. If the domain name with the particular extension is registered to a third-party, the client should investigate how it is being used.
c. If the domain name with the particular extension is registered to the client, the client may consider allowing the domain to expire and spending that budget on more important extensions.

3. If the risk score associated with an extension is less than the marginal risk level expressed by the customer, then the client may choose to ignore the risk as follows:
a. If the domain name with the particular extension is available for registration, it can be ignored.
b. If the domain name with the particular extension is registered to a third-party, it may be doing no harm and can be ignored.
c. If the domain name with the particular extension is registered to the client, the client should consider allowing the domain to expire and spending that budget on more important extensions.

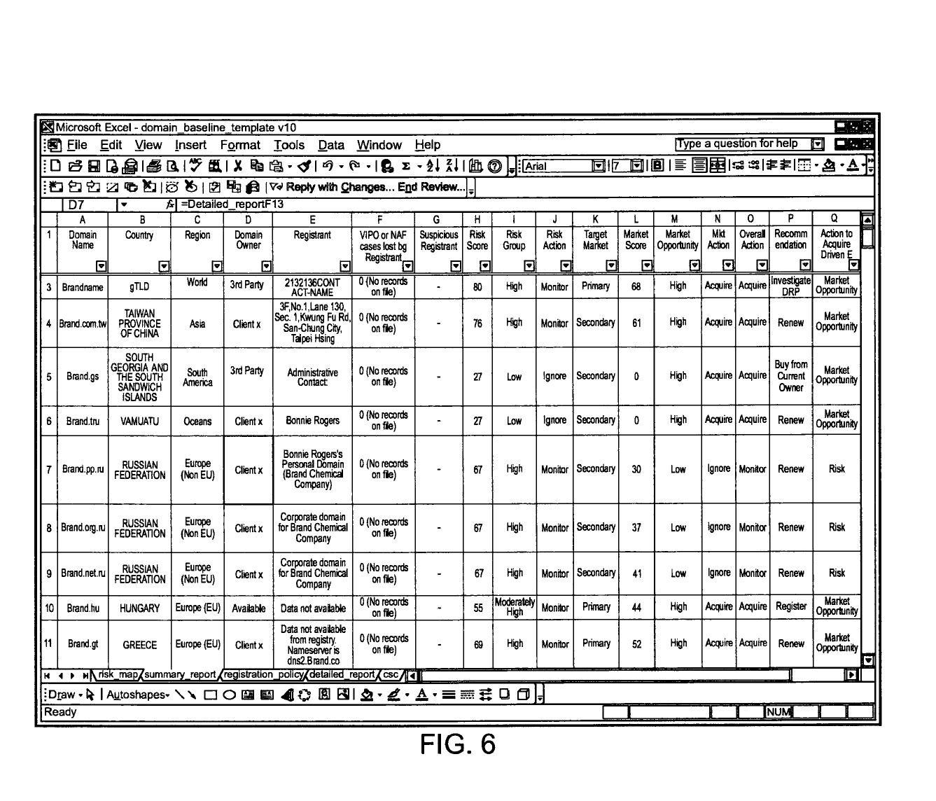

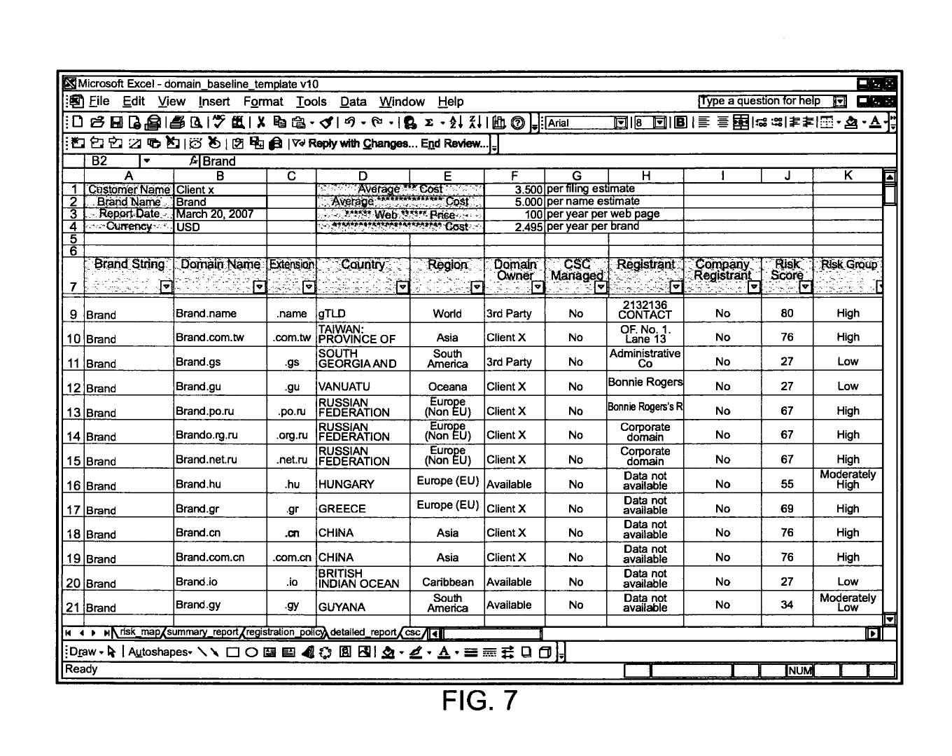

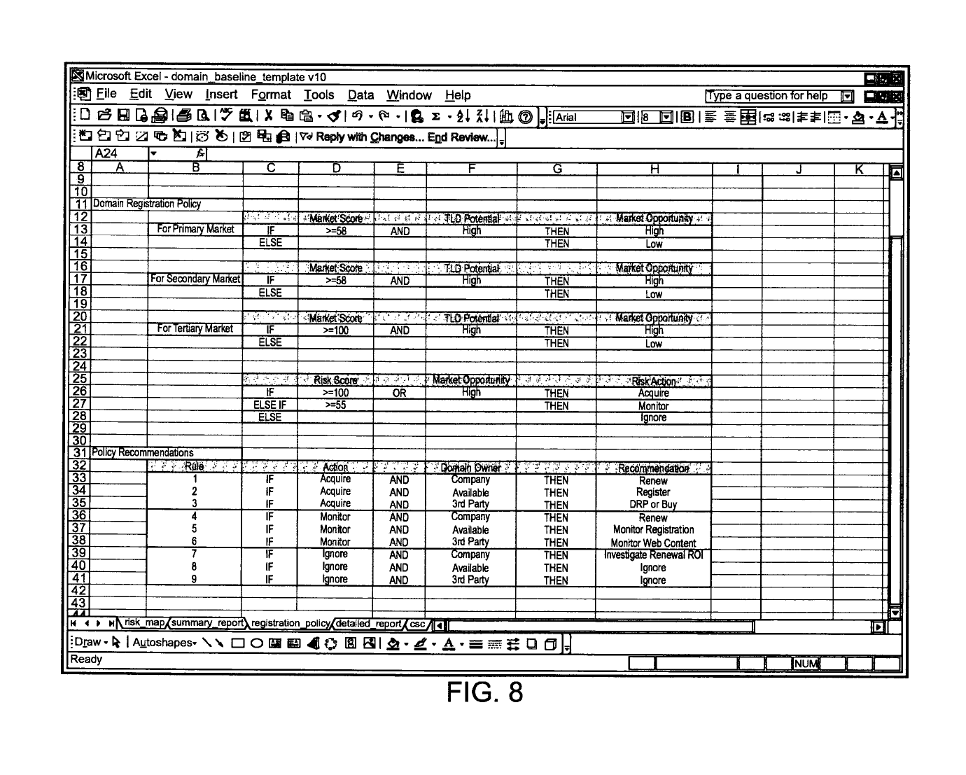

The user can view the underlying data for each domain name with a particular extension by clicking on the summary report tab 24 or the detailed report tab 28 (FIG. 2). An example of a summary report obtained by clicking tab 24 is illustrated in FIG. 6, and an example of a detailed report obtained by clicking tab 28 is illustrated in FIG. 7. The summary report of FIG. 6 lists the domain name with a particular extension in column A. The country and region associated with that extension are listed in columns B and C, respectively. Column D indicates whether the particular domain name is owned by the client, is owned by a third-party or currently is available. Column E indicates the name of the current registrant, and column F indicates the number of WIPO or NAF cases previously lost by the registrant. Column G can be used to indicate whether a particular registrant appears to be suspicious. Columns H, I and J indicate, respectively, the risk score for the domain name with the particular extension, a risk group based on the risk score (e.g., high, moderately high, low) and the proposed action based on the risk score. Columns K through Q provide additional information about the brand name combined with the listed extensions and are discussed below.

Based on the detailed risk exposure data in the reports of FIGS. 6 and 7 and the user-specified information (e.g., the user's risk tolerance indicated), the system automatically generates information that appears in the recommendations section 34 of FIG. 2. The recommendations section 34 displays, among other things, a high-level summary of the recommendations based on the risk exposure and risk tolerance information for all the brand names appearing in the risk map 36. Specifically, the area entitled “Risk Only” in the recommendations section 34 indicates the number of domain names for which a particular recommendation applies (e.g., register, renew, buy from current owner, investigate DRP, monitor web content, monitor domain registrations, investigate renewal return-on-investment, ignore) and the estimated costs associated with the recommended course of action. In the illustrated example, the system recommends that the brand owner monitor 86 domain registrations at an estimated cost of $2,495. The recommended actions and cost information appearing in the “Risk Only” area of the recommendations section 34 is based on the risk exposure data calculated by the system and the risk tolerance information selected by the user.

In some cases, the budget required to reduce the risk to the target level may be deemed to be unreasonable in view of the brand owner's budget. In that case, the user would increase the risk tolerance level (e.g., by moving the position of the bar 46 that appears below the risk map 36 in FIG. 2). Changing the risk tolerance level changes the number of domain names that fall within the unacceptable risk bracket. In particular, if the user adjusts the risk tolerance level, the system automatically re-determines the recommended action for each domain name (see column J of FIG. 6) based on the business logic rules discussed above. The system also automatically re-determines the information to be displayed in the recommendations section 34 (FIG. 2). The recommendations section 34, therefore, facilitates visualization of the recommended courses of action and budget forecasting to bring the brand in line with the client's specified level of risk tolerance. Thus, the system can help brand-owners determine how best to address the trade-off between risk and budget.

### Market Coverage

The system also can take account of, and provide recommendations based on, other factors such as market coverage, which is discussed in the following paragraphs.

The user-interface screen of FIG. 2 also includes a market coverage section 32, which allows the user to select a desired level of market coverage for the brand and to view a comparison of the desired coverage with recommended levels of coverage as determined by the system.

Based on information entered into the system about which geographic markets are most important to the brand owner, the system identifies each domain name as being associated with a primary, secondary or tertiary market (see column K of FIG. 6). The market coverage section 32 on the displayed user-interface screen (FIG. 2) indicates how many domain names fall into each geographic category. The market coverage section 32 also allows the user to adjust the position of bars 54A, 54B, 54C in user-selection tool area 56 so as to specify the number of domain names the user wants the brand owner to own in each geographical category. In the illustrated example of FIG. 2, the user-tool area 56 indicates that there are a total of 601 domain names (for the specified brand) in primary markets, twelve domain names in the secondary markets, and ten domain names in the tertiary markets. The current position of the movable bar 54A indicates a desired coverage of 285 domain names in the primary market.

A bar-graph 58 in the upper portion of the market coverage section 32 allows the user to view a side-by-side comparison of the selected level of market coverage in each market category with respect to an optimum or recommended level of coverage as determined by the system. The bar-graph 58 includes a pair of bars for each market category. In the illustrated example, the right-hand bar in each pair indicates the percentage of market coverage based on the level selected by the user using the movable bars 54A, 54B, 54C. The left-hand bar in each pair indicates the level recommended by the system. The system-recommended level is determined, for example, based on factors such as customer input identifying which countries or regions are most important as well as the system's determination regarding which domain extensions are most popular. In the illustrated example, the user-specified market coverage translates to about 44% of the domain names in the primary geographic markets, which, in this case, is the same as the coverage recommended by the system. Although the user need not select the same market coverage as recommended by the system, the comparison provided by the bar-graph 58 can assist the user in determining the best coverage for the brand owner.

The user-interface screen of FIG. 2 also displays a box 60 that provides a target market coverage score. The target market coverage score is calculated by the system based on the market coverage levels selected by the user in area 56. Another box 62 displays a current market coverage score, which is calculated by the system and reflects the actual market coverage of the brand owner based on the domain names it currently owns.

The summary report of FIG. 6 also includes a market score for each domain name (column L), where a high market score indicates an important geographic market. The summary report also indicates the market opportunity (e.g., high or low) in column M and the recommended action (e.g., acquire the domain name if possible; ignore) for the particular domain name in column N. The recommended action listed in column N is based on the market coverage score and on a set of business logic or policy rules implemented automatically by the system. The recommended action listed in column N is not, however, based on the risk score and the related information in columns H through J.

The recommendations section 34 in the user-interface screen of FIG. 2 also provides a summary of recommendations based on the user-selected market coverage. Specifically, the area entitled “”Mkt Opportunity Only” in the recommendations section 34 indicates the number of domain names for which a particular recommendation applies (e.g., register, renew, buy from current owner, investigate DRP, monitor web content, monitor domain registrations, investigate renewal return-on-investment, ignore) and the estimated costs associated with the recommended course of action. In the illustrated example, the system recommends that the brand owner seek to register 194 domain names at an estimated cost of $26,420. The recommended actions and cost information appearing in the “Mkt Opportunity Only” area of the recommendations section 34 is based on the market coverage data, but not the risk exposure data and the user-specified risk-tolerance information.

In some cases, the budget required to increase the market coverage to the target level may be deemed to be unreasonable in view of the brand owner's budget. In that case, the user would decrease the desired levels of market coverage (e.g., by moving the positions of one or more of the bars 54A, 54B, 54C in the user-selection tool area 56 in FIG. 2). Adjusting the market coverage level(s) changes the number of domain names that fall within the specified coverage. In particular, if the user adjusts the market coverage level, the system considers the top-ranked domain names (e.g., according to the market coverage scores in column L of FIG. 6) based on the number of domain names selected by the user in each geographic category (i.e., primary, secondary and tertiary) and automatically re-determines the number of domain names for which each type of recommended action applies. The system then automatically displays, in the “Mkt Opportunity Only” area of the recommendations section 34 (FIG. 2), the number of domain names for which each type of action is recommended, together with the estimated cost information. The recommendations section 34, therefore, facilitates visualization of the recommended courses of action and budget forecasting to bring the brand in line with the client's specified level of market coverage. Thus, the system can help brand-owners determine how best to address the trade-off between market coverage and budget.

As shown in the example of FIG. 2, the recommendations section 34 also includes a third area entitled “Risk & Mkt Opportunity” that provides recommendations and total cost estimates based on a combination of the risk analysis recommendations in the “Risk Only” area and the market coverage recommendations in the “Mkt Opportunity Only” area. If the system includes data for a particular domain extension in both the “Risk Only” and the “Mkt Opportunity Only” areas of the recommendations section 34, then that particular domain name will be counted only once when the system determines the combined information for the “Risk & Mkt Opportunity” area.

Thus, the interactive user-interface screen of FIG. 2 allows a user to adjust the level of risk tolerance as well as the level(s) of market coverage. The system automatically displays and updates the risk map to allow the user to visualize the risk to the specified brand name in a convenient way. The system also displays the user-specified levels of coverage in various geographical markets relative to system-recommended levels of coverage. The system provides a high-level summary of the recommended actions and estimated costs based separately on the user-specified risk and market coverage information, as well as based on a combination of the user-specified risk and market coverage information.

### Risk Engine

As noted above, the risk engine module is operable to obtain registry, market and client/brand data, and to quantify and predict the risk of improper or undesirable Internet use by a third party according to domain extension. In the illustrated implementation, this module uses fuzzy logic to calculate risk and to generate a risk score (and an associated risk rank) for each extension.

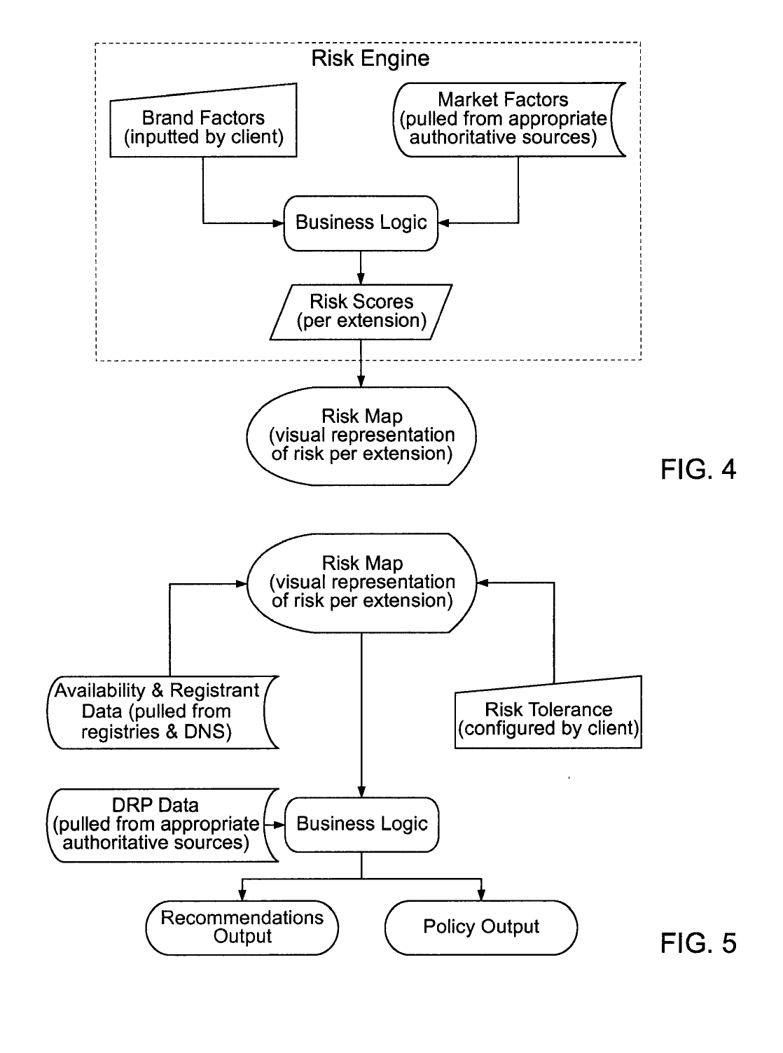

As indicated by the diagram of FIG. 4, the risk engine stores market and industry data that contribute to risk. Such data can be obtained automatically by the system from existing sources. The risk engine obtains and parses information about the status of domain names for a particular brand, reconciles that information to the client's profile, and determines whether the domains are registered to the brand or to a third-party.

The risk engine also accepts brand factors that contribute to risk. Such factors can be supplied by and entered into the system by the client or other user. Based on interaction rules (i.e., business logic), the risk engine reconciles the data sources to quantify the risk of improper or undesirable Internet use by a third party for each domain name extension. The risk engine then generates a risk score (e.g., between 0 and 100) that corresponds to the level of risk (in this case, 0 represents a low level of risk and 100 represents a high level of risk). The risk scores then are plotted on a risk map (e.g., risk map 36 in FIG. 2).

As explained above, the system allows a user to express a level of risk it deems to be acceptable and what level of risk it deems to be marginal. As shown in FIG. 5, the risk engine processes the user-specified level of risk tolerance so that it is reflected in the displayed risk map (FIG. 2) and in the information in the summary report (FIG. 6) and detailed report (FIG. 7).

In addition to the domain name availability and registrant data, the risk engine also can receive, store and display information relating to the availability of DRP at the registries associated with the domain name extensions. Such information can help the brand owner determine whether DRP may be available as a vehicle for reclaiming a domain name registered by a third-party or whether alternative approaches (e.g., purchasing the domain in question from the third-party) may be required.

As indicated by FIG. 5, using business logic and factoring in the availability of DRP, the risk engine generates a recommendation that, if executed by the brand owner, will align the brand owner's risk exposure with the user-specified risk-tolerance.

The risk engine also captures the brand owner's policy with respect to risk to enable the system to store the client's defensive registration policy, which can be used for other business purposes such as policy documentation and audit. As explained above, the policy is represented by a set of rules that drive decision-making and allow the system to propose a recommended course of action with respect to each domain name.

### Calculation of Risk Scores

As explained above, the risk engine is operable to generate a risk score for each domain name, where the risk score is indicative of the risk to the brand owner's brand. In the illustrated implementation, risk scores fall in the range of 0-100. A score closer to 100 presents a higher risk, whereas a score closer to 0 presents a lower risk.

In a preferred implementation, the risk score is based on several input variables including the market potential of the domain name, the cost of registering the domain name, and the applicable registry rules. In general, all other things being equal, the higher the market potential of the domain name, the greater the risk to the client's brand. Likewise, all other things being equal, the higher the cost of registering the domain name, the lower the risk to the client's brand. Similarly, the more stringent the eligibility criteria and requirements for the registration process, the lower the risk to the client's brand.

A particular implementation for obtaining the risk score is described in the following paragraphs. Other implementations may use different techniques.

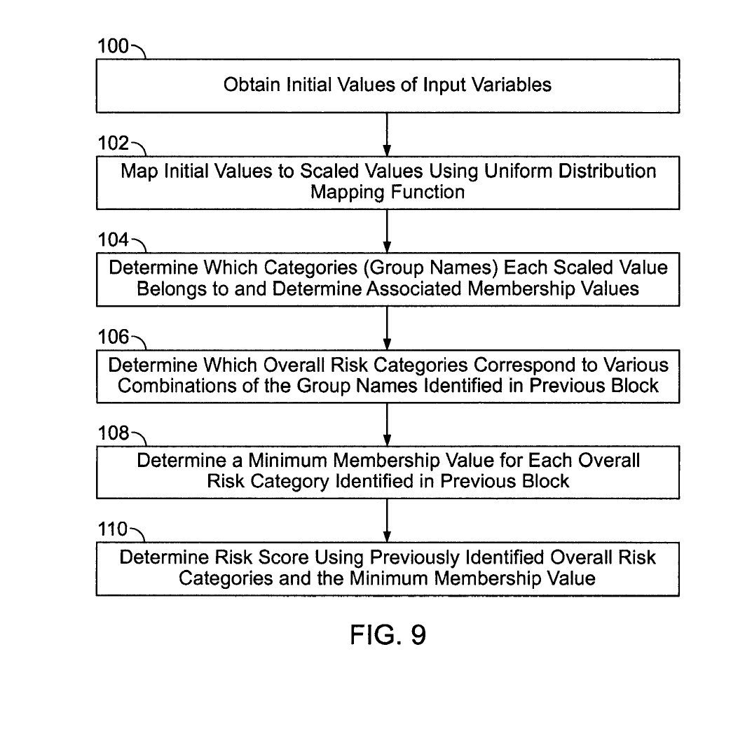

As illustrated by FIG. 9, to calculate the risk score for a particular domain name, the risk engine obtains an initial registry rules value, an initial registration cost value and an initial marketing potential value (block 100). The initial registration cost value represents an estimate of the cost of registering the particular domain name. As explained below, the initial registry rules value and the initial marketing potential value can be computed by weighing various factors. Examples of how that can be accomplished are discussed in subsequent sections below.

As indicated by block 102, each of the three initial values is mapped to a corresponding scaled value using a respective uniform distribution mapping function.

Next, as indicated by block 104, each of the scaled values is mapped to one or more categories, which may be referred to below as “group names.” The group names available for association with the registry rules value, the registration cost value and the marketing potential value need not be the same. In addition, the mapping to each group name has an associated membership value, which indicates the relative strength of the mapping to that group name. Each membership value has a value between zero and one.

As indicated by block 106, the risk engine then uses various combinations of group names associated, respectively, with the registry rules value, the registration cost value and the marketing potential value, to identify one or more overall risk categories. For example, in a particular implementation, the overall risk categories are as follows: very unlikely (i.e., very low risk to client's brand), unlikely, fairly unlikely, fairly likely, likely and very likely (i.e., high risk to client's brand). Each overall risk level corresponds to a range of risk scores. For example, “very unlikely” may correspond to risk scores in the range of 0-20, and “very likely” may correspond to risk scores in the range of 80-100. The risk engine uses predetermined rules, which are discussed in greater detail below, to identify which of the overall risk levels corresponds to each set of group names.

As indicated by block 108, the risk engine uses the membership values for the input categories (i.e., registry rules value, the registration cost value and the marketing potential value) to obtain a minimum membership value for each overall risk category.

Then, as indicated by block 110, the risk engine uses a weighted average technique to determine a single risk score for the domain name extension based, in part, on the overall risk categories previously identified and the corresponding minimum membership values.

Further details for a particular implementation of the process of FIG. 9 are set forth below. Other implementations, however, may use different techniques for calculating risk scores.

### Initial Input Variable Values

This following three sub-sections explain how the initial values of the input variables (registration cost, registry rules and market potential) are obtained according to some implementations.

### Initial Registration Cost Values

Initial registration cost values are based on average fees and other costs associated with registration a particular type of domain extension. The risk engine can use standard exchange rates to derive cost information in terms of a particular currency (e.g., U.S. dollars).

Initial Registry Rules Value

This section describes an implementation for calculating an initial registry rules value for a particular domain name extension. As mentioned above, in general, the more stringent the eligibility criteria and requirements for the registration process, the lower the risk to the client's brand.

Eligibility criteria are collected for registering under different domain extensions. That information is used to translate the registry rules into numerical values between 0 and 100. For example, if the eligibility criteria are very stringent, the domain extension is assigned a value of 100, which the system interprets as being “prohibitively” stringent.

### Initial Marketing Potential Value

This section describes an implementation for calculating an initial marketing potential value for a particular domain name extension.

The market potential of a domain name is indicative of how good a vehicle it would be for deriving internet traffic and, thus, is an expression of the marketability of the extension in question. As mentioned above, all other things being equal, the higher the market potential of the domain name, the greater the potential risk to the client's brand.

In some implementations, the initial marketing potential value is based on one or more of the following factors:

1. Market factors—i.e., “dollar audience” entitlement associated with the extension. Such market factors include:
a. Internet usage associated with the intended audience of the extension.
   i. gTLD extensions (e.g., .COM) command a global audience and therefore tend to be awarded higher internet usage figures.
   ii. CentralNIC extensions initially inherit the demographics associated with the country associated with the second-level extension (e.g., .DE.COM inherits the demographics associated with the .DE extension).
   iii. Certain ccTLD extensions have positioned themselves as being of generic use and marketing potential. Tuvalu, for example, was awarded the extension .TV. As it is a small Pacific-rim country, it recognized it had limited local demand for domain names, but could sell domains under the extension to television companies and programs wishing to promote themselves online. Such extensions can, therefore, be thought of more as generic TLDs, inheriting a percentage of the global online audience. Such top-level domains can be referred to as “positioned ccTLDs”.
   iv. Some extensions are regional and thus should inherit the demographics associated with that region. For example, .EU is targeted at the European Union's on-line audience; .ASIA, which is planned to be launched by the end of 2007, is targeted at Asia's on-line audience. For these “regional extensions,” the risk engine pulls the demographics of the corresponding region.
   v. Certain countries (e.g., China) have second-level extensions for each of their provinces (e.g., Beijing uses the extension .BJ.CN). For these “provincial extensions,” the risk engine considers the demographics associated with the particular province rather than the whole country.
b. Gross domestic product (“GDP”) per capita of Internet users associated with the intended audience of the extension.

2. Brand factors—the extent to which the brand is recognized and has the potential to drive internet traffic in a particular extension. Such brand factors include:
a. Market strategy—if a brand is not marketed or known in a particular country, the risk of improper or undesirable use by a third party is lower. The risk engine accommodates the extent to which the brand conducts business or intends to conduct business in the country associated with the extension.
b. Brand strength—the stronger the brand, the greater the potential value to a third-party (i.e., the greater the ability of the brand to drive Internet traffic).
c. Industry type—certain industries are more prone to improper use of the client's brand name. The selling of counterfeit goods and phishing scams provide third-parties with a very lucrative business model. The risk engine takes account of the fact that industries which are susceptible to such activities (e.g., luxury goods and financial institutions) are more prone to such improper use.

The foregoing factors can be quantified to provide an initial marketing potential value. Examples are provided in the following paragraphs.
Before accounting for brand factors, the market potential of an extension can be set equal to its online audience entitlement multiplied by the associated GDP per capita:

Market potential=(online audience)*(GDP per capita). [Equation 1]
If the extension type=gTLD, then:
   (online audience)=(number of global Internet users), and
   (GDP per capita)=(GDP in the U.S.A.)
If extension type=ccTLD, then:
   (online audience)=(number of Internet users in the associated country), and
   (GDP per capita)=(GDP per capita of the particular country).
If extension type=regional, then:
   (online audience)=(summation of number of Internet users in region's member countries), and
   (GDP per capita)=(weighted average of GDP per capita of member countries).
If extension type=CentralNIC, then:
   (online audience)=(number of Internet users in the country with the same two-letter ISO country code associated with the second-level domain of the extension in question), and
   (GDP per capita)=(GDP per capita associated with that country.
      The risk engine then dampens these numbers by the relative importance of the extension with respect to the official ccTLD extension.
If extension type=positioned ccTLD, then:
   (online audience)=(% of global Internet users (configurable by extension)), and
   (GDP per capita)=(% of USA's GDP per capita).
If extension type=provincial ccTLD, then:
   (online audience)=(number of Internet users in the associated province), and
   (GDP per capita)=(GDP per capita of the province).

The risk engine then dampens the market potential value calculated by Equation 1 by taking account of the brand factor weightings, which can be captured and stored during a client on-boarding process:

Market potential=(online audience)*(GDP per capita)*(brand factors),

where (brand factors)=(market strategy)*(brand strength)*(industry type).

In this example, market strategy is expressed at a country level as primary, secondary or tertiary. A percentage weighting (e.g., between 0 and 100) may be assigned to primary, secondary and tertiary market strategies, with each country inheriting the appropriate weighting. Brand strength and industry type are expressed as a percentage (i.e., between 0 and 100).

### Uniform Distribution Mapping

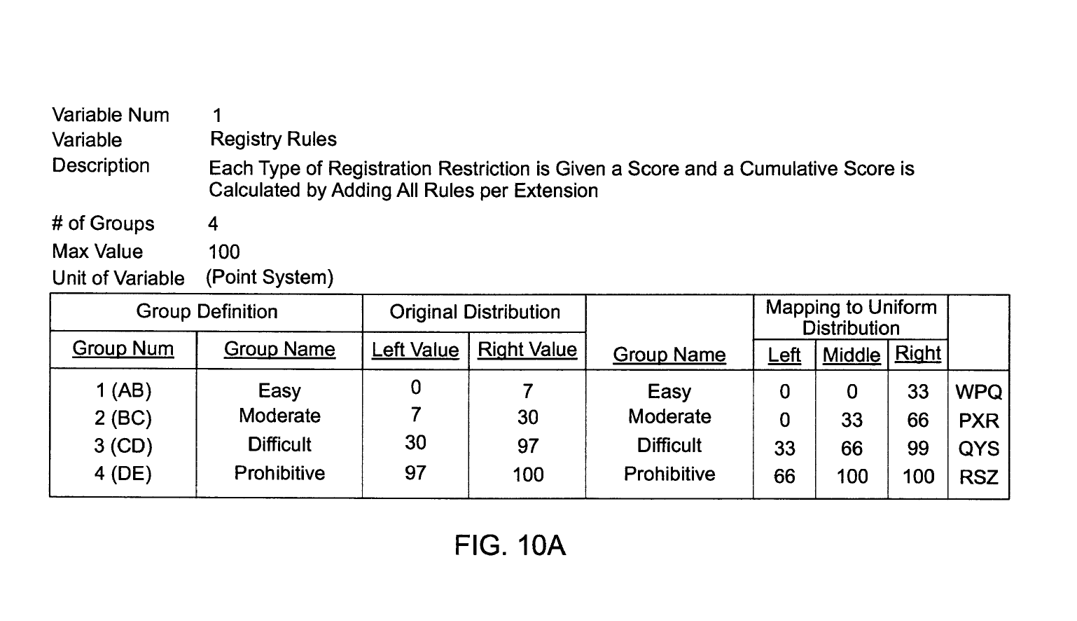

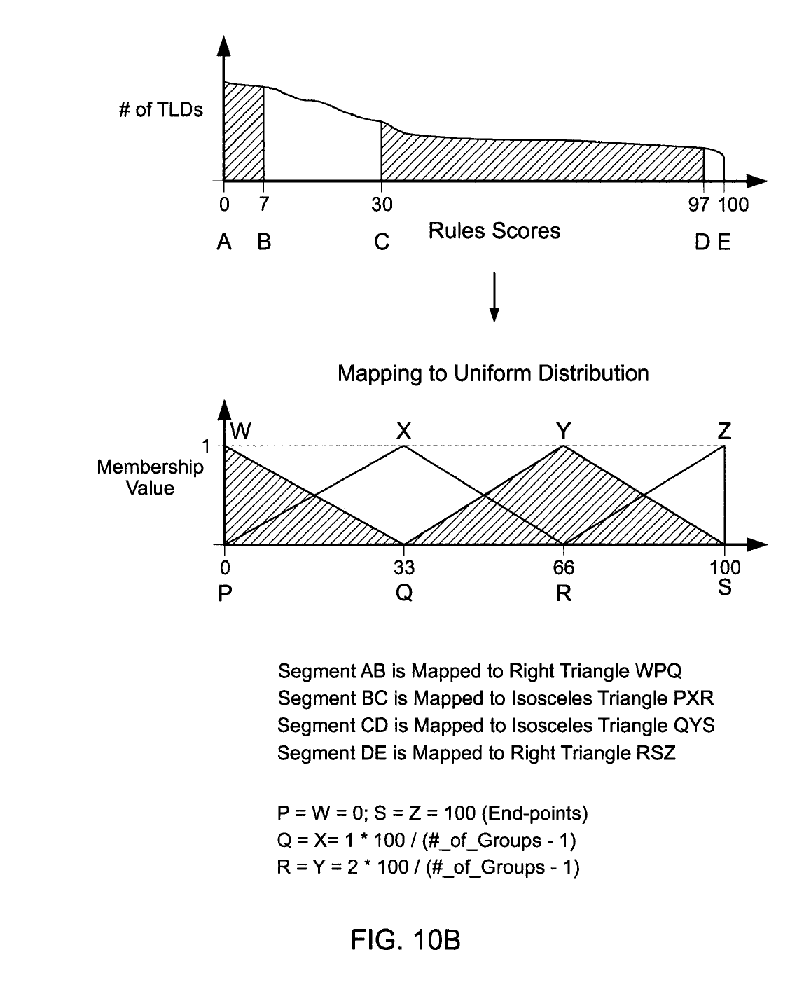

FIGS. 10, 11 and 12 illustrate examples, respectively, of uniform distribution mapping for the registry rule values, the registration cost values and the marketing potential values.

The original distributions for each input variable (i.e., registry rules, registration cost and marketing potential) are divided into segments, with each segment represented by left (low) and right (high) values that define the initial range for that segment. Because the segments in the original distributions may have unequal lengths, a uniform mapping function is used to transform the segments for each particular input variable to a right triangle or an isosceles triangles represented by left, middle and right values. The ranges defining each segment in the original distribution are configurable by the user.

For example, FIGS. 10A and 10B illustrate a mapping for the registry rules values. In this example, it is assumed that the registry rules for a particular domain name are assigned an initial value between 0 and 100. In the illustrated example, each initial registry rules value falls into one of four categories (also referred to as group names): Easy, Moderate, Difficult or Prohibitive. Values of 1-7 are in the Easy category, and values of 7-30 are in the Moderate category. Other values are in either the Difficult or Prohibitive categories. Each of the initial distributions is mapped to a corresponding right triangle or isosceles triangle as illustrated in FIGS. 10A and 10B.

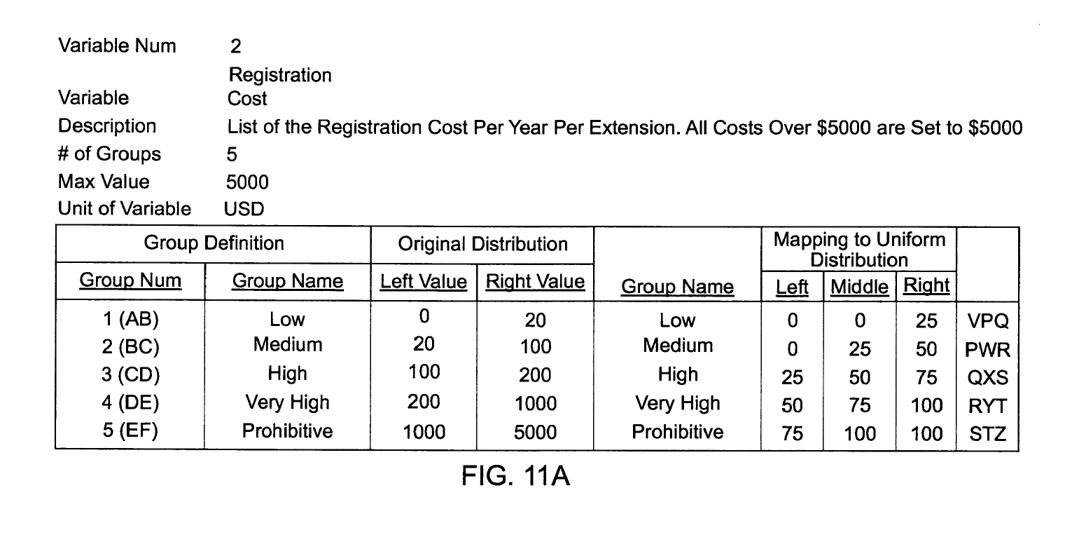

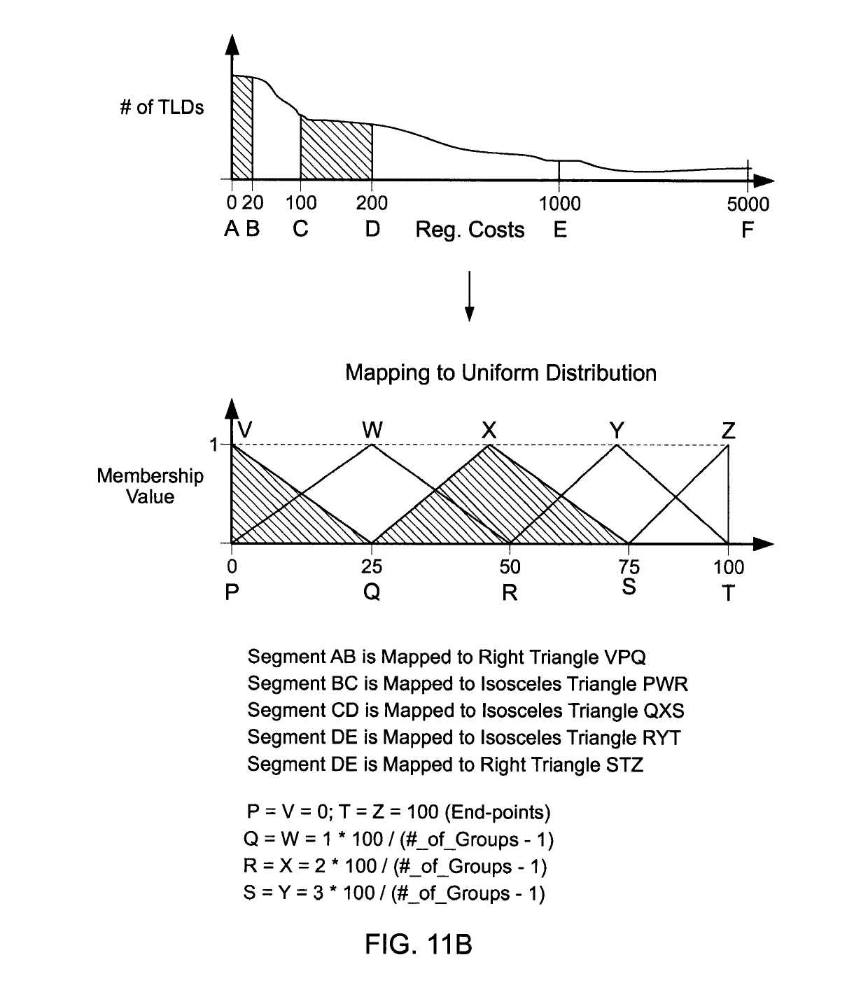

FIGS. 11A and 11B illustrate an example of the mapping for the registration cost values. In this example, it is assumed that the registration costs range from $0 to $5,000. Each initial registration cost value falls into one of five categories (also referred to as group names): Low, Medium, High, Very High, Prohibitive. Values of $0-20 are in the Low category, and values of $20-100 are in the Medium category. Other values are in the High, Very High or Prohibitive categories. Each of the initial distributions is mapped to a corresponding right triangle or isosceles triangle as illustrated in FIGS. 11A and 11B.

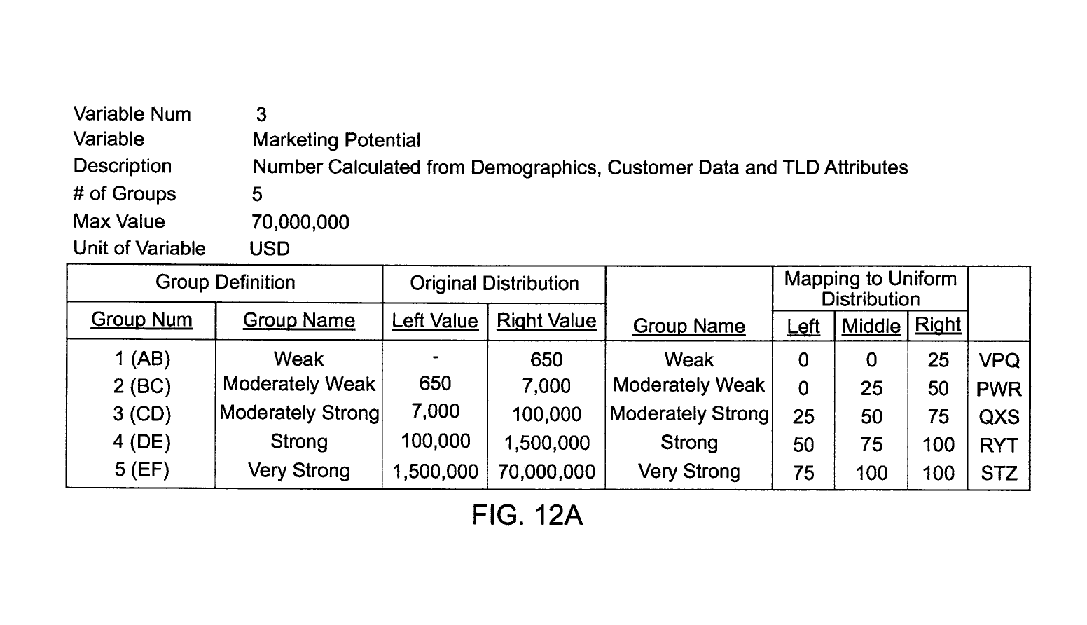

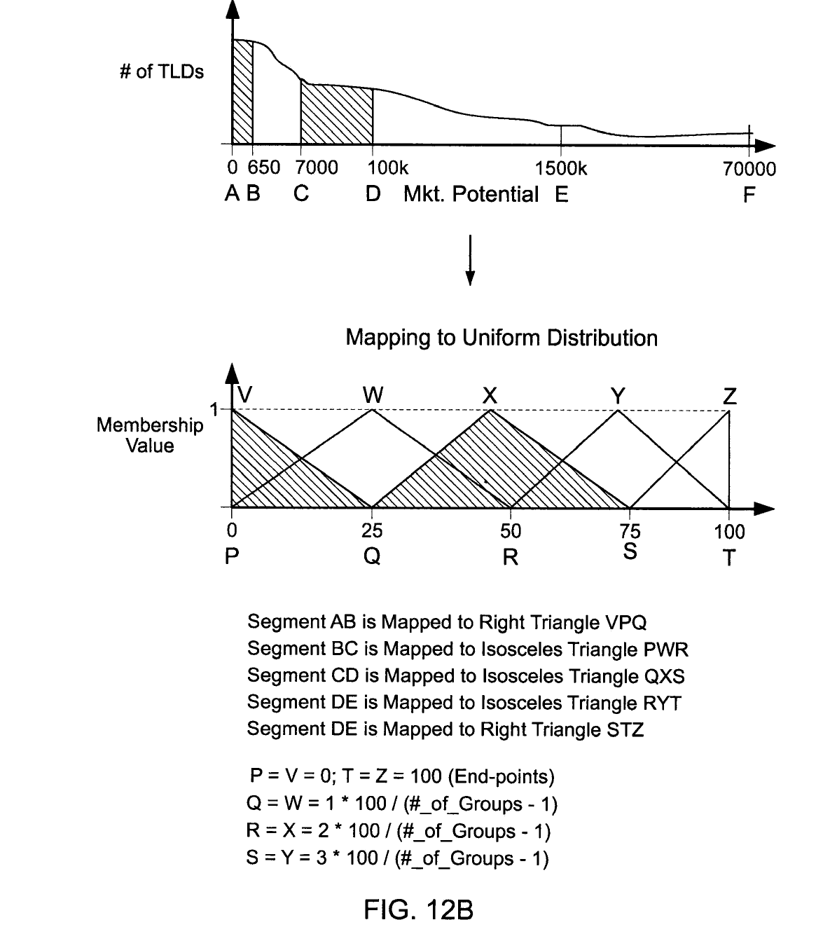

FIGS. 12A and 12B illustrate an example of the mapping for the marketing potential values. In this example, it is assumed that the marketing potential values range from $0 to $70,000,000. Each initial marketing potential value falls into one of five categories (also referred to as group names): Weak, Moderately Weak, Moderately Strong, Strong and Very Strong. Values of $0-650 are in the Weak category, and values of $650-7,000 are in the Moderately Weak category. Other values are in the Moderately Strong, Strong or Very Strong categories. Each of the initial distributions is mapped to a corresponding right triangle or isosceles triangle as illustrated in FIGS. 12A and 12B.

### Scaled Values

Using the uniform mapping distributions, the risk engine determines a respective scaled value (“SS”) for each of the initial values (i.e., registry rules value, registration cost value and marketing potential value) associated with a particular domain name extension.

In a particular implementation, the scaled values are calculated as follows. First, the risk engine determines the category (i.e., group name) in which the initial value (“OS”) lies. The risk engine also determines the left value (“OL”) and right value (“OR”) for that group name (see, e.g., left-hand side of FIGS. 10A, 11A, 12A). For the same group name, the risk engine determines the middle value (“UM”) and right value (“UR”) in the corresponding uniform distribution mapping function (see, e.g., right-hand side of FIGS. 10A, 11A, 12A).

The risk engine then computes the relative position (“RP”) of the initial value (“OS”) as follows:

RP=(OS−OL)/(OR−OL).

The scaled value (“SS”) corresponding to the particular initial value then is computed as follows:

SS=UM+(UR−UM)*RP.

### Membership Values

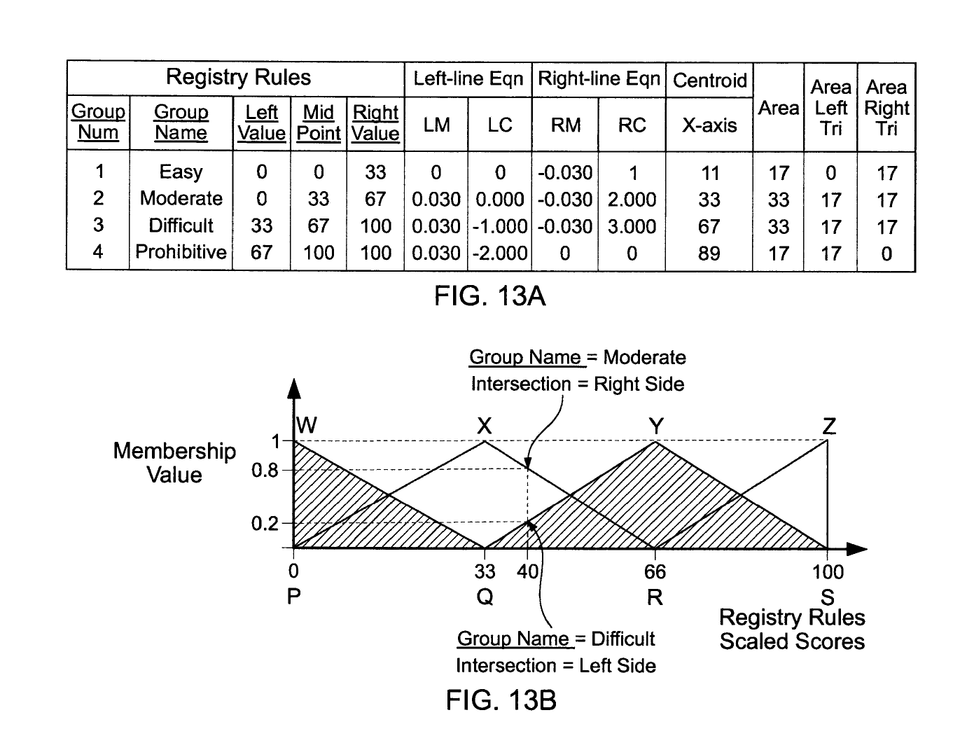

For each scaled value (“SS”), the risk engine uses the respective uniform distribution mapping (e.g., FIGS. 10B, 11B, 12B) to determine the triangle(s) that correspond to the range(s) within which the scaled value lies. For example, as shown in the example of FIG. 13B, if the scaled registry rules value equals 40, then the risk engine would determine that the scaled value intersects the right-hand side of the triangle for the Moderate group and the left-hand side of the triangle for the Difficult group.

The risk engine then calculates a membership value (“MV”) for each group name that the risk engine determined is associated with the scaled value. In the illustrated implementation, the membership values are calculated as follows. If the scaled value (“SS”) intersects the left-hand side of the triangle, then:

MV=SS*LM+LC,

where LM and LC represent, respectively, the slope and constant in an equation (e.g., y=(LM)*X+(LC)) defining a line corresponding to the left-hand side of the triangle. Likewise, if the scaled value (“SS”) intersects the right-hand side of the triangle, then:

MV=SS*RM+RC,

where RM and RC represent, respectively, the slope and constant in an equation (e.g., y=(RM)*X+(RC)) defining a line corresponding to the right-hand side of the triangle.

FIG. 13A is a table listing examples of values for LM, LC, RM and RC for the various categories (i.e., group names) in the Registry Rules input variable. As illustrated in the example of FIG. 13B, for a scaled value (“SS”) of 40, the membership value (“MV”) associated with the Moderate group is 0.8, whereas the membership value (“MV”) associated with the Difficult group is 0.2. In the illustrated example, the scaled value of 40 is associated with two group names. Other scaled values (e.g., 33 and 66), however, may be associated with more than two group names.

The membership values are used to obtain the risk score as explained in the following section.

### Risk Score

The input variables (registration cost, registry rules and market potential) typically interact in a complex manner because the variables are not equally important and because their relative importance may change depending on circumstances. The risk engine accounts for such factors, as explained below.

After the risk engine maps each of the scaled scores for the three input variables to the corresponding group names and associated membership values, the risk engine maps each possible combination of the corresponding group names (where each combination includes one group name for each input variable) to corresponding output group names (“EQ”) in accordance with predefined rules. Although the rules are predefined, they are configurable by the user. By mapping different combinations of the three input variables, the system determines which rules are satisfied and returns an output (“EQ”) together with the rule identifiers.

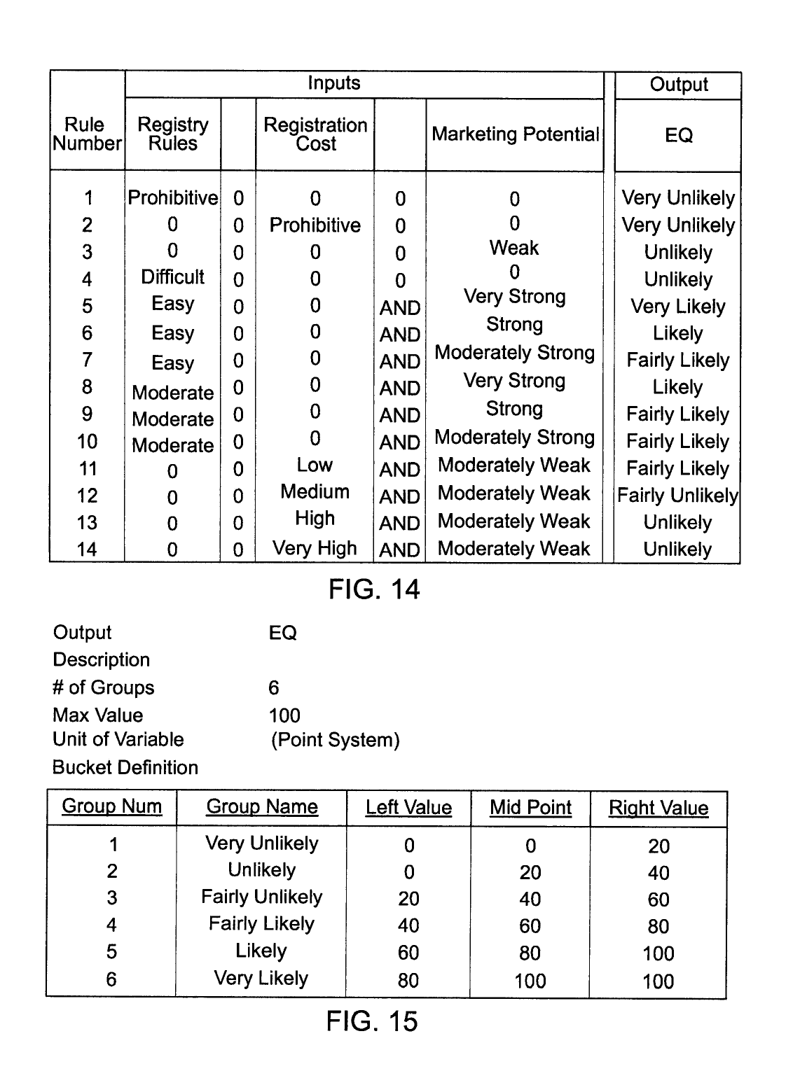

FIG. 14 provides a table that lists examples of rules that provide a mapping between different combinations of group names for the three input variables and the corresponding group name associated with the output (“EQ”). In the illustrated example, a “0” indicates that the identity of the particular group name does not matter for that rule. For example, rule 1 indicates that if the group name for the Registry Rules input variable is “Prohibitive,” then the output (“EQ”) is set to the “Very Unlikely” category. Likewise, rule 6 indicates that if the group name for the Registry Rules input variable is “Easy” and the group name for the Marketing Potential input variable is “Strong,” then the output (“EQ”) is set to the “Likely” category. The risk engine thus identifies each rule that is satisfied by at least one combination of the group names previously determined to correspond to the scaled values for the input variables.

For each of the foregoing rules in FIG. 14 that is satisfied, the risk engine also determines a minimum membership value associated with the output value (“EQ”). The respective minimum membership values are based on predefined rules using the membership values associated with the group names for the input variables. In the illustrated example, the following rules are used to determine the minimum membership value:
IF the registry rules membership value≧the registration cost membership value AND the registration cost membership value≧the market potential membership value, THEN the minimum membership value=the market potential membership value.
IF the registry rules membership value≧the registration cost membership value AND the market potential membership value≧the registration cost membership value, THEN the minimum membership value=the registration cost membership value.
IF the registry rules membership value≦the registration cost membership value AND the registration cost membership value≦market potential membership value, THEN the minimum membership value=the registry rules membership value.

IF the registry rules membership value≦the registration cost membership value AND the registry rules membership value≦market potential membership value, THEN the minimum membership value=the registry rules membership value.

IF the registration cost membership value≧the market potential membership value AND the market potential membership value≧the registry rules membership value, THEN the minimum value=the registry rules membership value.

IF the registry rules membership value≦the registration cost membership value AND the market potential membership value≦the registration cost membership value, THEN the minimum membership value=the market potential membership value.

As explained below, the risk engine uses the output values (“EQ”) identified above and the associated minimum membership values to calculate the risk score.

As with the input variables, each category (i.e., group name) for the output (“EQ”) has an associated left (lower) value, mid-point value, and right (higher) value that define the range of scores for the particular category. FIG. 15 lists an example of the group names and corresponding ranges for the output (“EQ”). The ranges defining each segment are configurable by the user. Also, as described above with respect to the input variables, a uniform mapping function transforms each segment for the output (“EQ”) to a right triangle or an isosceles triangles represented by left, middle and right values. As with the mappings for the input variables, each triangle in the uniform distribution mapping for the output (“EQ”) has a respective area size and a centroid x-axis value, which are used below to calculate the risk score for the domain name extension.

The risk score can be calculated by the risk engine as follows:

For each output value (“EQ”) identified above using the various combinations of group names for the input variables, calculate:

(area_x_min_value)=(minimum membership value)×(area of the triangle in the uniform distribution mapping that corresponds to the output value),

(centroid_area_x_value)=(area_x_min_value)×(centroid x-axis value for the triangle in the uniform distribution mapping that corresponds to the output value).

Then:
CWIO=the sum of the values (area_x_min_value) calculated above,
WCM=the sum of the values (centroid_area_x_value) calculated above.

Finally, the risk score=WCM/CWIO.

The risk score can be mapped to the corresponding risk category (e.g., Very Likely, Very Unlikely, etc.) of FIG. 15.

### Domain Name Monitoring Module With Domain Web Content Classification

As explained above, the risk engine 18 module addresses risk based, for example, on domain name extensions for situations in which there is an exact match to the domain string used by the brand owner. However, as previously noted, depending on the risk scores and the user-specified risk tolerance and market coverage, the risk engine module can recommend that the brand owner monitor the status of domain names with particular extensions.

In addition to risk associated with domain names that use the same domain string as the brand owner, risk to the brand also can occur if a third-party uses a variant of the domain name such as a misspelling or other change.

A domain name monitoring module 22 with domain web content classification can be integrated into a system with the risk engine and risk map modules. The monitoring module is operable to classify risk based on (a) the similarity of a domain string to a brand name and (b) the web content to which the domain is pointing. For example, as noted above, an exact match of the brand name is more likely to be confused with the brand name and present a higher risk than a typographical or other variant. Similarly, a negative reference or a site with adult content may present a higher risk to the brand name. On the other hand, if the third-party domain name is not pointing to any web content, it is likely to be less harmful to the brand.

This module can be used as part of a domain name monitoring system which facilitates the monitoring of registrations that represent exact matches, variants and misspellings of the client's brand. The results are categorized for relevance at the domain and web content level. The results then are prioritized based on domain and web category (e.g., negative reference within the domain name; pornographic or other adult content), website activity (e.g., active or inactive), registrant and geographical factors (e.g., primary or secondary market).

In some implementations, this module monitors the Internet for new registrations and extracts core elements of each new domain name. For example, the module can extract the type of name, the country or region where the domain is registered, the geographic market and the registrant's identity.

The module then categorizes the web content for each newly registered domain that is detected. In a particular implementation, there are various web categories (e.g., no site, adult content, pay-per-click) and various domain categories (e.g., exact match to the brand, negative reference, misspelling, etc.). Based on that information, the module calculates a score for each newly detected domain name and generates a priority ranking for the new domain names. Thus, the module identifies the results that present the greatest risk to the brand under consideration.

The domain name monitoring module can be configured to take account of factors identified by the brand owner as most important. Configuration can be implemented without the need to customize software.

The registrant data can be reconciled against WIPO and NAF domain disputes to facilitate building enforcement cases.

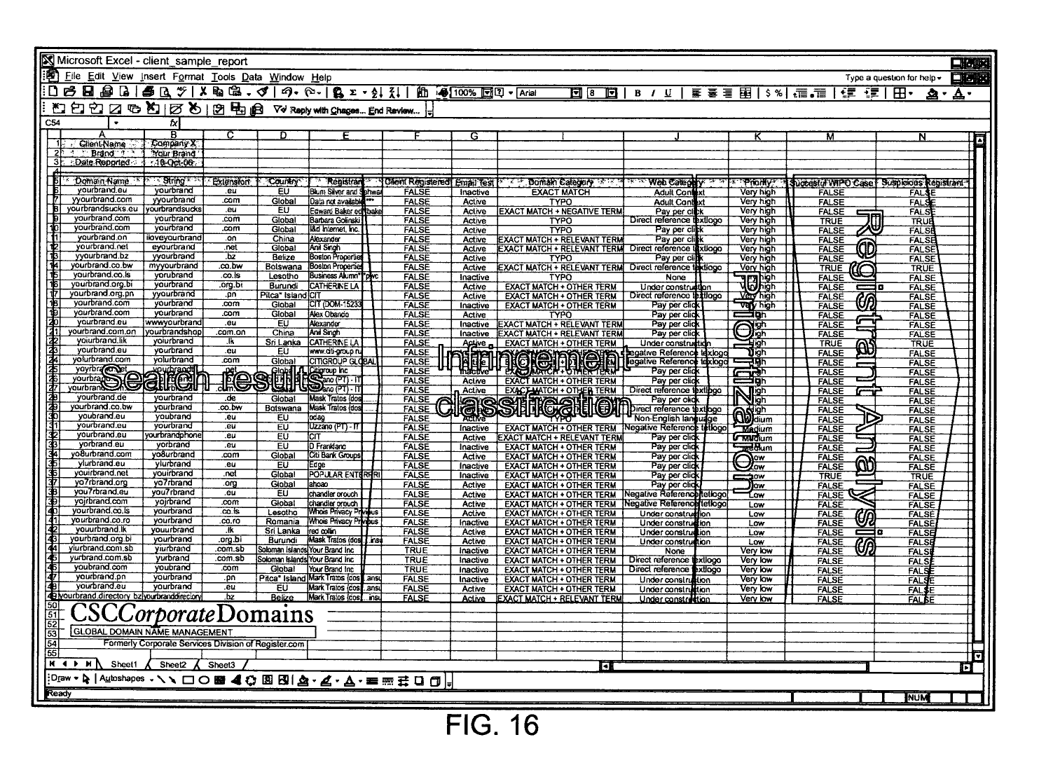

The module can generate a report that is transmitted to the brand owner on a periodic basis, such as once a month or once a year. In some implementations, the system provides the report to the client or other user in electronic form so that it can be displayed and viewed on the user's personal computer or other device. FIG. 16 illustrates an example of a report based on output generated by the monitoring module. As shown in FIG. 16, the report includes search results, classification results, prioritization results and results of registrant analysis.

In the illustrated example, the search results include a listing of each domain name for which a new registration is detected, as well as a listing of the domain string, the extension, the country in which the domain is registered and the name of the registrant. The classification results include an indication of whether the domain name is registered in the name of the client and an indication of whether the corresponding web site is active or inactive based, for example, on an e-mail test. The classification results also identify the domain category (e.g., exact match to the brand, negative reference, misspelling, etc.) and the web category (e.g., no site, adult content, pay-per-click). The prioritization results include an indication of the priority ranking (e.g., very high, high, medium, low, very low). The results of the registrant analysis include an indication of whether there has been a successful WIPO case and an indication as to whether the registrant is categorized as “suspicious.”

Other implementations may provide different or additional information in the report.

### String Parser Module

As explained above, the system can include a left-hand-side (“LHS”) and right-hand-side (“RHS”) string parser module 24 that parses out the left-hand-side and right-hand-side strings of wildcard variants. This data can be used to spot trends in improper or undesirable third-party behavior. For example, the module can determine that a third-party favors the LHS string “www”, as it seeks to benefit from people typing in a URL such as “www.csc.com” without the dot (i.e., “wwwcsc.com”).

Details of the logic to decompose domains and thereby identify left-hand-side and right-hand-side strings that might wrap brands are explained below according to a particular implementation.

The module divides domains by string and extension. For example, in the case of “abcproduct.com”, the string is “abcproduct” and the extension is “.com”. The module removes any hyphens from the domain to ensure that it can match it to a brand (e.g., “abc-product.com” should be treated the same as “abcproduct.com”). In an Excel implementation, the logic for this is SUBSTITUTE(domain,“-”,“”), which implements a search for any hyphens in the domain and replaces them with nothing. This value can be referred to as “hyphenless string.”

Next, the module parses the hyphenless string of the domain, which forms the basis of the reconciliation to the brand. Thus, the system searches for the character string to the left of the first dot in the hyphenless domain.

The module determines where the first dot appears. (Some domains are registered under top-level domains, such as .COM, and so will only have one dot, whereas others are registered under second-level domains, such as .CO.UK, and so will have two dots). In a particular implementation, the module derives a numerical value using the Excel formula SEARCH(“.”, hyphenless domain). For example, in the case of “abcproduct.com”, the result will be 11 (i.e., the dot appears in the 11th character position of the string).

Next, the module searches for the characters that comprise the hyphenless domain up to the first dot. In the foregoing example, the module looks at the first ten characters of “abcproduct.com”—i.e., “abcproduct”. Formulaically, if the dot appears in character position N, the module can parse the string from the hyphenless domain by retrieving the first (N−1) characters. In an Excel system, the formula is LEFT (hyphenless domain, SEARCH (“.”,hyphenless domain)−1).

The string parser module 24 also is operable to parse the extension from a domain automatically. To do so, the module determines where the first dot appears using the formula SEARCH(“.”,hyphenless domain). The module then looks for the last N characters of the domain string. The module should be configured to recognize that (a) some domains are registered under top-level domains while others are registered under second-level domains, and (b) domain extensions vary in length (e.g., .COM is only four characters long, whereas .AVOCAT.FR is ten characters long). Therefore, the module calculates the length of the entire hyphenless domain using the formula LEN(hyphenless domain).

The number of characters that constitute the extension of the hyphenless domain is equal to the length of the hyphenless domain minus the position in which the first dot appears plus 1. The module adds the “1” so as to include the dot in the extension (this is the industry norm). For example, in the domain “abcproduct.com”, the dot first appears in position 11; the length of the entire domain is 14; the string after the first dot is thus 3 characters in length; the string to the right of the first dot and including the first right dot is therefore 4 characters in length. In an Excel system, this can be calculated using the following formula: LEN(hyphenless domain)−SEARCH(“.”,hyphenless domain). The module then determines the actual final N characters of the hyphenless domain. Substituting in all the previous formulae, the number of N characters can be calculated using the following Excel formula: RIGHT(hyphenless domain,(LEN(hyphenless domain)−(SEARCH(“.”,hyphenless domain,1))+1)).

The next calculation reconciles the hyphenless domain to a list of brands (or trademarks/tradenames) to look for exact matches. This can be accomplished by using the following Excel formula: NOT(ISNA((VLOOKUP(hyphenless string,list of brands,1,FALSE)))). The result is a Boolean value: TRUE indicates that the hyphenless string is an exact match of a value in the list of brands; FALSE indicates that it does not exactly match any value in the list of brands. For example, if the domain is “abcproduct.com” and there is a value “abcproduct” in the list of brands, the expected value would be TRUE.

The module then searches for wildcard matches of the domain with respect to the list of brands/trademarks. Some domains may include multiple entries in the brands/trademarks list. For example, if the company is ABC and has a product (“PRODUCT”), the company may have registered ABC and ABCPRODUCT as trademarks/brands. For this reason, the module runs the reconciliation against the list of brands/trademarks listed in reverse alphabetical order so that a wildcard match of ABCPRODUCT takes precedent over a wildcard match of ABC. To run the reconciliation, the module searches for each of the entries in the trademarks/brands list in the hyphenless string. If a wildcard match is encountered, the module returns a value of TRUE; if a wildcard match is not encountered, the module returns a value of FALSE. For example, if there is a value in the list of trademarks/brands called ABCPRODUCT, the following domains would be considered wildcard matches: “wwwabcproduct.com”, “abcproducts.co.uk” and “wwwabcproductsucks.com.fr”.

The module now knows which domains are wildcard matches and the brand/trademark that is included in the domains in question. Next, the module determines the character strings in the domain that do not specifically relate to the brand/trademark. The module identifies left-hand-side (LHS) and right-hand-side (RHS) strings. In the case of “wwwabcproduct.com”, the brand match is “abcproduct”, and the module should identify a LHS string of “www”. In the case of “abcproducts.co.uk”, the module should identify a RHS string of “s”. In the case of “wwwabcproductsucks.com.fr”, the module should identify a LHS string of “www” and a RHS string of “sucks”. Such information can assist brand-owners to build and prioritize their brand protection strategy.

To calculate the LHS string, the module identifies the characters to the left of where the brand string starts in the domain. Using the example domain of “wwwabcproduct.com” and assuming that the module already has determined there is a wildcard match of the brand/trademark “abcproducts”, the brand string “abcproducts” starts in the fourth character position of the domain. The module can calculate this using the Excel formula SEARCH(brand,hyphenless string). Therefore, if N=the character position in which the brand string starts, the module looks for the first (N−1) characters of the hyphenless domain string to determine the LHS string. In the case of “wwwabcproducts.com”, the module would look for the first (4−1)=3 characters, which give “www”. The Excel formula is LEFT(hyphenless string,SEARCH(brand,hyphenless string)−1).

To calculate the RHS string, the module searches for the characters to the right of where the brand string ends in the hyphenless string. For example, in the domain “abcproducts.co.uk”, the module already has determined that there is a wildcard match of the brand/trademark “abcproducts”. The brand string “abcproduct” starts in the first character position of the domain (determined using the aforementioned logic); the brand string “abcproduct” is ten characters in length; the length of the hyphenless domain string is 11 characters, The module calculates how many characters constitute the RHS string. It can do this by subtracting the character position in which the brand starts, subtracting the length of the brand string from the length of the hyphenless domain string, and adding 1. In the case of “abcproducts.co.uk”, this will result in (11−1−10+1)=1. In this example, the module now knows to look for the last 1 character(s) of the hyphenless string=“s”. In the example of “wwwabcproductsucks.com.fr”, the length of the hyphenless domain string is 18; the length of the brand (“abcproduct”) is 10; the brand starts in the 4th character position of the domain; and the length of the RHS string is (18−4−10+1)=5. The module thus knows to look for the last 5 characters of the hyphenless string=“sucks”.

When the module applies this logic to a brand-owner's portfolio of domain names (which can number in the thousands) or to a third-party's activities in the domain space, the results can help the brand owner more quickly understand the composition of huge volumes of domain names. This, in turn, can help clients make informed decisions as to the value of domains, enabling them to (a) reduce their costs by identifying domain name registrations they can allow to lapse and (b) increase revenues by registering domains that may be prone to improper or undesirable third-party use and, therefore, drive traffic.

Other implementations are within the scope of the claims.

1. A machine-implemented method comprising:
acquiring data relating to a name, wherein the name represents at least on of the following: a brand name, a domain name, a trademark, a service mark or a business entity name;
based at least in part on the acquired data, quantifying risks to the name in the event a third-party has obtained, or were to obtain, a registration to the same name or a variant of the name, wherein a risk score is associated with each potential or actual registration; and
providing an interactive display showing the risk scores.

2. The method of claim 1 including displaying a radar chart on which the risk scores are plotted, wherein a distance from the center of the radar chart to a location at which a particular risk score is plotted corresponds to the value of that risk score.

3. The method of claim 2 including different symbols or other features on the radar chart to differentiate between risk scores for registrations listed in the name of a specified entity, risk scores listed in the name of other entities, and risk scores associated with unregistered names.

4. The method of claim 2 wherein each risk score is plotted on the radar chart at a distance from the center that is inversely proportional to the value of that risk score.

5. The method of claim 2 wherein the radar chart includes one or more rings whose centers coincide with the center of the radar chart, wherein each ring represents a different range of risk, and wherein the ranges are defined based on a user-specified risk-tolerance.

6. The method of claim 5 including updating the size of the rings in response to a user changing the risk-tolerance.

7. The method of claim 2 wherein each risk score is based at least in part on one or more of the following input variables: costs of registration, market potential in a geographic area covered by the registration, and stringency of eligibility requirements for registration.

8. The method of claim 7 wherein each risk score is based at least in part on each of the following input variables: costs of registration, market potential in a geographic area covered by the registration, and stringency of eligibility requirements for registration.

9. The method of claim 8 including mapping each of the input variables to a respective scaled value using a uniform distribution mapping function.

10. The method of claim 9 wherein each scaled score is associated with one or more categories of risk, the method including assigning a corresponding membership value to each risk category, wherein the membership value is indicative of a relative strength of the scaled score to the risk category.

11. The method of claim 10 including using the scaled scores and membership values to obtain a corresponding risk score.

12. The method of claim 1 including providing an interactive display showing cost estimates associated with recommended actions, wherein the recommended actions are based on: the risk scores, a user-specified risk-tolerance, and whether or nor individual names are registered to a particular entity or some other entity or are unregistered.

13. The method of claim 12 including updating the displayed recommended actions and associated cost estimates in response to a user's changing the risk-tolerance.

14. The method of claim 1 including:
associating each actual or potential registration with a primary or other market; and
providing an interactive display showing the number of registrations in each market.

15. The method of claim 14 wherein the display includes cost estimates associated with recommended actions, wherein the recommended actions are based on the risk scores and respective numbers of registrations in each market that a user specifies should be registered to a particular entity.

16. The method of claim 15 including updating the recommended actions and associated cost estimates in response to the user changing the respective numbers of registrations within each market that should be registered to the particular entity.

17. The method of claim 1 including providing an interactive display showing cost estimates associated with recommended actions, wherein the recommended actions are based on: the risk scores, a user-specified risk-tolerance, whether or nor individual names are registered to a particular entity or some other entity or are unregistered, and respective numbers of registrations in each market that a user specifies should be registered to a particular entity.

18. The method of claim 17 including updating the displayed recommended actions and associated cost estimates in response to a user's changing the risk-tolerance or changing the respective numbers of registrations within each market that should be registered to the particular entity.

19. The method of claim 1 including:
obtaining data relating to actual and potential registrations of a domain name with different extensions,
wherein each risk score represents a risk to a particular entity's brand name if a third-party already has obtained, or were to obtain, a registration to the domain name with a particular one of the extensions.

20. The method of claim 1 including:
monitoring data relating to registrations for variants of the name;
determining a risk to the name for each variant; and
establishing a listing indicative of which registrations for variants of the name should receive priority attention.

21. The method of claim 1 wherein a relatively higher risk score indicates a relatively higher risk.

22. A system comprising:
one or more servers operable to:
acquire data relating to a name that represents at least one of the following: a brand name, a domain name, a trademark, a service mark or a business entity name;
based at least in part on the acquired data, quantify risks to the name in the event a third-party has obtained, or were to obtain, a registration to the same name or a variant of the name, wherein a risk score is associated with each potential or actual registration; and
provide an interactive display showing the risk scores; and
one or more databases storing the data and the risk scores; and
a user device coupled to the one or more servers to receive the interactive display.

23. An article comprising a machine-readable medium that stores machine-executable instructions for causing a machine to:
acquire data relating to a name that represents at least one of the following: a brand name, a domain name, a trademark, a service mark or a business entity name;
based at least in part on the acquired data, quantify risks to the name in the event a third-party has obtained, or were to obtain, a registration to the same name or a variant of the name, wherein a risk score is associated with each potential or actual registration; and
provide an interactive display showing the risk scores.

24. A machine-implemented method for assessing risk to a specified name that represents at least one of a brand name, a domain name, a trademark, a service mark or a business entity name, the method comprising:
monitoring domain name activity; and
classifying risk based on (i) similarity between a domain string of a monitored domain name and the specified name and (ii) a type of web content in a web site to which the monitored domain name is pointing.

25. The method of claim 24 monitoring domain name activity includes monitoring new domain name registrations.

26. The method of claim 24 wherein classifying risk based on similarity of a domain string includes differentiating between an exact match and a typographical or other variant.

27. The method of claim 24 wherein classifying risk based on similarity of a domain string includes taking into consideration whether the domain string of a monitored domain name includes a negative reference regarding the specified name.

28. The method of claim 24 wherein classifying risk based on type of web content includes taking into consideration whether the web site includes pornographic or other adult content.

29. The method of claim 24 including:
categorizing results of the monitoring based on relevance at the domain and web content level; and
prioritizing the results based on domain and web category, website activity and registrant and geographical factors.

30. The method of claim 24 including generating a report based on risk classification.

31. A system comprising:
one or more servers operable to:
monitor domain name activity; and
classify risk based on (i) similarity between a domain string of a monitored domain name and a specified name that represents at least one of a brand name, domain name, trademark, service mark or business entity name and (ii) a type of web content in a web site to which the monitored domain name is pointing; and
one or more databases to store information about the monitored domain name activity and the risk; and
a user device coupled to the one or more servers to receive information about the risk.

32. An article comprising a machine-readable medium that stores machine-executable instructions for causing a machine to:
monitor domain name activity; and
classify risk based on (i) similarity between a domain string of a monitored domain name and a specified name that represents at least one of a brand name, domain name, trademark, service mark or business entity name and (ii) a type of web content in a web site to which the monitored domain name is pointing.

33. A machine-implemented method of assessing risk to a specified name that represents at least one of a brand name, a domain name, a trademark, a service mark or a business entity name, the method comprising:
monitoring domain name activity; and
parsing left-hand-side and right-hand-side strings of a monitored domain name that is a variant of the specified name.

34. A system comprising:
one or more servers operable to:
monitor domain name activity; and
parse left-hand-side and right-hand-side strings of a monitored domain name that is a variant of a specified name representing at least one of a brand name, domain name, trademark, service mark or business entity name; and
one or more databases to store information about the monitored domain name activity and the parsed left-hand-side and right-hand-side strings; and
a user device coupled to the one or more servers to receive information about the monitored domain name activity and the parsed left-hand-side and right-hand-side strings.

35. An article comprising a machine-readable medium that stores machine-executable instructions for causing a machine to:
monitor domain name activity; and
parse left-hand-side and right-hand-side strings of a monitored domain name that is a variant of a specified name representing at least one of a brand name, domain name, trademark, service mark or business entity name.
